(19) United States
(12) Patent Application Publication
(10) Pub. No.: US 2004/0129388 A1
(43) Pub. Date: Jul. 8, 2004

(54) Non-marring tire lever

(76) Inventor: Bill Thomas Brazil, Pennington, NJ (US)

Correspondence Address: BILL T. BRAZIL, 15 PLYMOUTH ST., PENNINGTON, NJ, 08534, US

(21) Appl. No.: 10/723,360

(22) Filed: Nov. 26, 2003

Related U.S. Application Data
(60) Provisional application No. 60/435,462, filed on Dec. 20, 2002.

(51) Int. Cl. B60C 25/04

(52) U.S. Cl. 157/1.3

(57) ABSTRACT

The present invention relates to a tire tool, also referred to as a tire lever, wherein the tire tool is used for mounting a tire to and/or dismounting a tire from a wheel rim, wherein the tire tool comprises a non-marring polymer coating.

This applications claims priority from copending provisional application No. 60/435,462, filed Dec. 20, 2002, the entire disclosure of which is hereby incorporated by reference.

### FIELD OF THE INVENTION

The present invention generally relates to the fields of automotive tools and tire removal/installation. More particularly, the invention relates to a non-marring tire lever for use in mounting, installing and/or removing a vehicle tire from its wheel rim.

### BACKGROUND OF THE INVENTION

Various manual and powered tools for installing and removing tires from wheel rims are known in the art. For example, U.S. Pat. Nos. 2,311,789, 2,344,704, 4,461,335, 5,265,661, 5,343,921, 5,417,270, 6,269,861, the Myers Tire Supply catalogue (Myers Industries, Inc.; Akron, Ohio), the Motion Pro® catalogue (Motion Pro®, Inc.; San Carlos, Calif.) and the Ken-Tool® catalogue (Ken-Tool®; Akron, Ohio) describe numerous tire tools (e.g., tire irons, tire levers, tire spoons, etc.) for installing and removing tires from wheel rims. For example, tire tools listed in the Myers Tire Supply catalogue range in sizes from 18 inches to 56 inches and come in various tool end configurations (e.g., straight spoon, curved spoon, drop center, offset, tubeless, super single mount and center post).

In the manual version, tire tools generally comprise an elongated pry bar handle, which is gripped by a user, and a flattened tool end for insertion between the tire bead and the wheel rim. The process of disengaging the tire from the rim of a wheel is frequently referred to as “bead breaking”. The bead of a tire is generally wire reinforced and resists deformation. The tire bead is usually intended to seal a mounted tire to the wheel rim. For this purpose, the bead has a diameter that is somewhat less than the diameter of the wheel rim flange and resides between the spaced flanges of the wheel rim, wherein the bead is extremely difficult to break. Many of today's tires, in particular, sport or low profile tires, motorcycle tires, so called “run-flat” tires and All Terrain Vehicle (ATVs) tires, have further complicated the task of bead breaking.

To remove a tire from a rim, a working end of a tire tool (e.g., a tire lever) is inserted between the tire bead and the rim flange. The user applies pressure to the opposite handle end of the tool, using the tool as a lever and the wheel rim as a fulcrum. A short length of the tire bead is lifted axially over the rim flange. This process is repeated in successive stages to increase the length of the bead on the axial outside of the rim flange (often using two, three or more tire levers around the periphery of the wheel rim to hold a portion of the bead against “popping” back over the rim flange) while more of the bead is pried over the rim flange. After a certain angular span has been passed over the rim flange, prying at a distance from that span (e.g., at a diametrically opposite position) pulls the bead portion that is already outside the rim radially inwardly on the outside, rather than tending to pull that portion back between the rim flanges. It becomes easier to pass the remainder of the bead axially over the rim until the entire tire bead resides outside the rim. After the tire bead is broken, the tire is then stripped from the rim of the wheel. For installing a tire on a wheel rim, the foregoing process is carried out in reverse order.

A common problem encountered when “bead breaking” a tire, or mounting and/or dismounting a tire from the wheel rim, is marring (or disfiguring) the wheel rim, particularly the rim flange. A further problem encountered when “bead breaking” a tire, or mounting and/or dismounting a tire from the wheel rim is that the tire bead and/or the side wall is torn or punctured by the tire tool. As described above, when “bead breaking” a tire, a working end of a tire tool (e.g., a tire lever) is inserted between the tire bead and the rim flange, wherein the user applies pressure to the opposite handle end of the tool, using the tool as a lever and the wheel rim as a fulcrum. The composition of tire levers, often called “tire irons” (e.g., forged steel, aluminum, chrome-vanadium steel, etc.), is such that the tire tool, acting as a lever, often disfigures, damages or mars the surface of the wheel rim. To overcome this problem of wheel rim marring on bicycle rims, Park Tool Company (St. Paul, Minn.) sells a bicycle tire lever made of glass-injected nylon. However, tire levers of such compositions (i.e., a non-metal composition) are not suitable for “bead breaking” tires on car rims, motorcycle rims, ATV rims, trailer rims and the like, as the tire lever would not withstand the forces needed to engage a tire bead, and/or lever a tire bead and/or pry a tire bead away from a wheel rim.

Alternatively, companies such as Ken-Tool® (Akron, Ohio) and Dual Star (Lynnwood, Wash.) sell leather and plastic protectors, respectively, which fit over the wheel rim flange. The leather rim protector, which is about three inches wide and five inches in length, is placed over a section of the rim flange (i.e., about three inches) to prevent contact between the rim and tire lever. The plastic rim protector, which has a curved shape and about four to five inches in length, clips onto the rim edge to prevent damage to rim surfaces. However, neither the leather or the plastic protects the rim in the event that the tire lever slips off of the protective material (i.e., beyond the three inch leather zone or five inch plastic zone). In addition, these rim protectors must be moved around the circumference of the rim flange in incremental steps during the mounting or dismounting, steps which may be tempting to omit when mounting and dismounting several tires or when in a rush or hurry. A further shortcoming of the above rim protectors, is that the thickness of the protectors (e.g., 5-10 mm), makes it more difficult for the tire lever to fit between the tire bead and the rim flange, thereby increasing the difficulty of the bead breaking process.

The problem of wheel rim marring is compounded and quite costly when the user of the tire lever is inexperienced and/or a “do it yourself” mechanic. For example, motorcycles do not have the storage capacity to carry a spare tire as found in most automobiles. Thus, the motorcyclist must carry a tire repair kit, which typically includes a tire patch, a tire plug, a spare tire tube (i.e., an inner tube), at least two tire levers, wrenches, etc. If the motorcycle happens to have a flat tire on a remote or isolated road, the only “cost effective” option is for the motorcyclist to repair the tire, which involves the “bead breaking” and removal/installation steps described supra. During such “road side” tire repair, the motorcycle wheel rim and flange are subjected to the levering forces of the tire lever, with the tire lever often damaging or marring the surface of the wheel rim.

Another scenario of wheel rim damage or marring occurs at “automotive shops” (e.g., an automotive service center, an automotive tire store, a local mechanic, etc.). Automotive shops typically use “conventional” pneumatically powered tire processing machines. Conventional powered tire processing machines require the user to mount the wheel on a spindle and initially pry a portion of the tire bead over the wheel rim (i.e., “break the bead”) to engage the machine tooling (i.e., a pneumatically operated “machine” tire tool). Thus, a short length of the tire bead is pried over the rim flange with a hand held tire tool. The machine tire tool is then placed under the lifted bead and engaged with a pneumatically operated driving shaft on the spindle, whereupon an end of the machine tool is passed circumferentially around the periphery of the wheel rim flange, pulling the bead over the rim flange. For rigid tires this task can be virtually impossible for a single person to accomplish. The end result of this process is that the tire tool, fixed to, and operated via the circumferentially rotating driving shaft, damages or mars the wheel rim flange due to metal on metal contact. In addition to wheel rim marring, the tire tool often tears or damages the tire bead and/or the side wall of the tire.

The cost and extent of damage to a wheel rim incurred during “bead breaking” a tire, or mounting and/or dismounting a tire is directly related to the wheel rim composition. Wheel rims typically comprise materials such as steel, stainless steel, hardened “alloy” steel, chrome plated steel, chrome-vanadium steel, aluminum, magnesium, titanium, carbon fiber, Kevlar®, and the like. Many wheel rims also comprise a decorative clear coating over the metal. These clear coats are easily scratched during the tire mounting/dismounting process and are quite costly to have repaired. Magnesium, aluminum and carbon fiber wheels are often used on racing vehicles due to their diminished reciprocating mass, and are also gaining popularity in the U.S. and Asian sport car market, commonly referred to as “G-cars”. The price for wheel rims range from around fifty dollars per wheel (e.g., a chrome plated steel rim) to a thousand dollars per wheel (e.g., magnesium and carbon fiber rims). Additionally, if the damage to a wheel rim is repairable, the cost ranges anywhere from one hundred to three hundred dollars. It is therefore highly desirable when mounting (or dismounting) new tires to these rims, that the tools used in mounting process do not damage or mar the wheel rims and/or the tire.

A further source of wheel rim damage arises from the wheel weights which are used to balance a tire mounted to its wheel rim (e.g., see U.S. Pat. No. 4,728,154, incorporated herein by reference in its entirety). For example, after a tire has been mounted to a wheel rim, the wheel rim is placed on a tire balancing machine which spins the wheel for about thirty seconds to a minute. A computer, which is connected to the balancing machine, then indicates the specific locations that are out of balance on the wheel rim and how much weight is needed at each location to bring the wheel into balance. The wheel weights (also known as wheel balance weights) are made of lead alloy and have a hook (or clip) that attaches to the rim flange. When a wheel weight(s) is/are added to a wheel rim, they are often a source of wheel rim marring. Further, if the wheel weights are not removed before mounting or dismounting the tire, the action of the tire tool as it rotates around the circumference of the rim flange, will drag the weight across the rim causing further damage or marring to the rim.

Thus, there is a need in the art for an effective, non-marring tire tool for use in “bead breaking”, mounting and/or dismounting tires such as car tires, sport car tires, low profile tires, motorcycle tires, trailer tires, recreational vehicle (RV) tires, so called “run-flat” tires, All Terrain Vehicle (ATVs) tires and the like.

### SUMMARY OF THE INVENTION

The present invention is directed to a tire tool, also referred to as a tire lever, wherein the tire tool is used for mounting a tire to and/or dismounting a tire from a wheel rim, wherein the tire tool comprises a non-marring surface coating. A tire tool of the invention is also referred to in the art as a tire lever or a tire iron.

In one embodiment, a tire changing tool comprising (a) a lever, wherein the lever has a first lever end portion, a second lever end portion and a lever body connecting the first and second end portions and (b) a polymer coating, wherein the polymer coating covers at least one lever end portion. In certain embodiments, the polymer coating is further defined as being permanently bound to the entire surface area of at least one lever end portion the tire tool. In other embodiments, the polymer is a plastic polymer. In certain other embodiments, the plastic polymer is further defined as a thermoplastic, a cross-linked thermoplastic, a thermoset or a thermoplastic elastomer. In one particular embodiment, the plastic polymer comprises one or more polymers (or polymer starting materials) selected from the group consisting of a polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde and a vinyl acetate. In certain embodiments, the entire surface area of the first lever end comprises a polymer coating and the entire surface area of the second lever end comprise a polymer coating. In certain other embodiments, the first lever end and the second lever end comprise a different polymer coating composition. In still other embodiments, the entire surface area of the lever comprises the polymer coating. In another embodiment, the tire lever is comprises of one or more materials selected from the group consisting of steel, stainless steel, hardened alloy steel, chrome plated steel, forged steel, chrome-vanadium steel, aluminum, magnesium, titanium, Kevlar® and carbon fiber. In one embodiment, the plastic polymer is an ionomer resin, wherein the ionomer resin is an ethylene/methacrylic acid. In another embodiment, the plastic polymer is a polyamide, wherein the polyamide is a nylon. In certain of these embodiments, the nylon is a nylon 6, a nylon 6,6, a nylon 6,9, a nylon 6,11, a nylon 6,12, a nylon 11 or a nylon 12. In other embodiments, the plastic polymer is a polyvinyl, wherein the polyvinyl is a polyvinyl chloride (PVC)/polyacrylic alloy. In still other embodiments, the plastic polymer is a polyvinylidene, wherein the polyvinylidene is a polyvinylidene fluoride (PVDF). In certain other embodiments, the plastic polymer is a fluoropolymer, wherein the fluoropolymer is a polytetrafluoroethylene (PTFE), a perfluoroalkoxy (PFA), a fluorinated ethylene propylene (FEP) or an ethylene tetrafluoroethylene (ETFE). In certain other embodiments, the tire tool further comprises one or more additional lever end portions connected to the lever body.

In still another embodiment, the tire tool further comprises a non-permanent polymer sheath. In certain embodiments, the polymer sheath comprises one or more polymers selected from the group consisting of a polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde and a vinyl acetate. In certain embodiments, the sheath covers the entire surface are of at least one lever end of the tire tool, wherein the lever end is defined as a lever end portion which engages a wheel rim. In other embodiments, the sheath covers the entirety of the tire tool. In one embodiment, the ionomer resin is an ethylene methacrylic acid. In another embodiment, the polyvinyl is a PVC/polyacrylic alloy. In still another embodiment, the polyamide is nylon. In yet other embodiments, the polyvinylidene is a PVDF. In certain other embodiments, the fluoropolymer is PTFE, PFA, FEP or ETFE.

In one embodiment, the invention is directed to a kit comprising (a) a tire changing tool, the tool comprising a lever having a first lever end portion comprising a permanent polymer coating, a second lever end portion comprising a permanent polymer coating and a lever body connecting the first and second end portion and (b) at least one polymer sheath. In certain embodiments, the polymer comprises one or more polymers (or polymer starting materials) selected from the group consisting of a polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde and a vinyl acetate. In one embodiment, the permanent polymer coating is further defined as permanently bound to the entire surface area of the first lever end portion of the tire tool and permanently bound to the entire surface area of second lever end portion the tire tool. In other embodiments, the permanent polymer coating is bound to the entirety of the tire tool. In other embodiments, the polymer is a plastic polymer. In one particular embodiment, the ionomer resin is an ethylene/methacrylic acid. In another embodiment, the polyamide is a nylon. In certain of these embodiments, the nylon is a nylon 6, a nylon 6,6, a nylon 6,9, a nylon 6,11, a nylon 6,12, a nylon 11 or a nylon 12. In yet other embodiments, the polyvinyl is a PVC/polyacrylic alloy. In still other embodiments, the polyvinylidene is a PVDF. In other embodiments, the fluoropolymer is PTFE, PFA, FEP or ETFE. In certain other embodiments, the tire lever is comprises one or more materials selected from the group consisting of steel, stainless steel, hardened alloy steel, forged steel, chrome plated steel, chrome-vanadium steel, aluminum, magnesium, titanium, Kevlar® and carbon fiber. In certain embodiments, the polymer sheath comprises one or more polymers selected from the group consisting of a polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde, and a vinyl acetate. In other embodiments, the kit further comprises one or more tire lubricating agents in a suitable container means, wherein a lubricating agent is selected from the group consisting of a detergent, a soap, an oil, a silicon, a water based jelly, a mineral oil, a graphite and a rust inhibitor.

In another embodiment, the invention is directed to a plastic sheath for covering a lever end of a tire tool, wherein the plastic sheath covering the lever end of the tire tool prevents the marring of a wheel rim when the lever end contacts the wheel rim during a tire mounting or dismounting process. In certain embodiments, the polymer comprises one or more polymers (or polymer starting materials) selected from the group consisting of a polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde and a vinyl acetate. In one particular embodiment, the ionomer resin is an ethylene/methacrylic acid. In another embodiment, the polyamide is a nylon. In certain of these embodiments, the nylon is a nylon 6, a nylon 6,6, a nylon 6,9, a nylon 6,11, a nylon 6,12, a nylon 11 or a nylon 12. In yet other embodiments, the polyvinyl is a PVC/polyacrylic alloy. In still other embodiments, the polyvinylidene is a PVDF. In other embodiments, the fluoropolymer is PTFE, PFA, FEP or ETFE.

Other features and advantages of the invention will be apparent from the following detailed description, from the preferred embodiments thereof, and from the claims.

### BRIEF DESCRIPTION OF THE DRAWINGS

FIG. 1 is a non-limiting example of a commonly used steel tire lever having two lever ends used to engage a tire bead. FIG. 1A is a top view and FIG. 1B is side of the tire lever. The tire lever comprises a first lever end portion 1, a second lever end portion 2 and a lever body 3 connecting the first and second lever end portions.

FIG. 2 is a top view (FIG. 2A) and a side view (FIG. 2B) of the same tire lever depicted in FIG. 1, now comprising a non-mar polymer coating of the invention. FIG. 2A and FIG. 2B show the tire lever comprising a first lever end portion 1 coated with a non-mar coating (black), a second lever end portion 2 coated with the same or a different non-mar coating (black) and a lever body 3 connecting the first and second lever end portions.

FIG. 3 is a side view of a steel tire lever having two lever ends used to engage a tire bead and a non-mar plastic polymer sheath 4 of the invention. The sheath 4 is a pre-formed non-mar polymer which fits over a lever end portion 2 of the tire lever 3.

### DETAILED DESCRIPTION OF THE INVENTION

The present invention addresses a need in the art for an effective, non-marring tire tool for use in “bead breaking”, mounting and/or dismounting tires such as car tires, sport car tires, low profile tires, motorcycle tires, trailer tires, recreational vehicle (RV) tires, so called “run-flat” tires, All Terrain Vehicle (ATVs) tires and the like.

Thus, the invention described hereinafter is directed to a tire tool used for “bead breaking” a tire, mounting a tire and/or dismounting a tire from a wheel rim, wherein the tire tool comprises a non-marring polymer coating, wherein the polymer coating reduces or prevents damaging, marring or disfiguring of the wheel rim. In certain embodiments, a tire tool comprising a non-marring polymer coating prevents the tire bead and/or the side wall from being torn or punctured during the tire mounting and/or dismounting process. As defined hereinafter, a “wheel rim”, a “wheel” and a “rim”, are used interchangeably. As defined hereinafter, the term “bead breaking” includes the process of mounting a tire to a wheel rim and the process of dismounting a tire from a wheel rim. Similarly, the terms “tire bead”, “engage a tire bead”, “lever a tire bead” and “pry a tire bead” all refer to the process of removing a tire from a wheel rim and mounting a tire to a wheel rim.

### A. THE TIRE TOOL

In certain embodiments, the invention is directed to a tire tool comprising a lever, wherein the lever has a first lever end portion, a second lever end portion and a lever body connecting the first and second end portion, and a non-marring polymer coating.

As defined hereinafter, the terms “tire changing tool”, “tire tool”, “tire lever” and “tire iron” are used interchangeably, and refer to any tool or apparatus used to engage a tire bead. As defined hereinafter, a “non-marring” tire tool of the invention is any tire tool or apparatus used to engage a tire bead, wherein the non-marring tire tool comprises a non-marring polymer coating (e.g., a protective barrier) and thereby reduces or prevents damaging, marring or disfiguring of the wheel rim.

A non-marring tire tool of the invention is used to engage a tire bead of both tube and tubeless tires. A non-marring tire tool comprises various tire tool shapes, sizes, lever end configurations and/or lever body configurations, all of which are well known in the art (e.g., see U.S. Pat. Nos. 2,311,789, 2,344,704, 4,461,335, 5,265,661, 5,343,921, 5,417,270 and 6,269,861, each specifically incorporated herein by reference in its entirety). For a comprehensive review of tire tool shapes, sizes and/or configurations contemplated for use as “non-mar” tire tools of the present invention, refer to the Myers Tire Supply catalogue (Myers Industries, Inc., Akron, Ohio), the Motion Pro catalogue (Motion Pro, Inc., San Carlos, Calif.), the Ken-Tool® catalogue (Ken-Tool®; Akron, Ohio) and the Park Tool Company world wide web catalogue (St. Paul, Minn.).

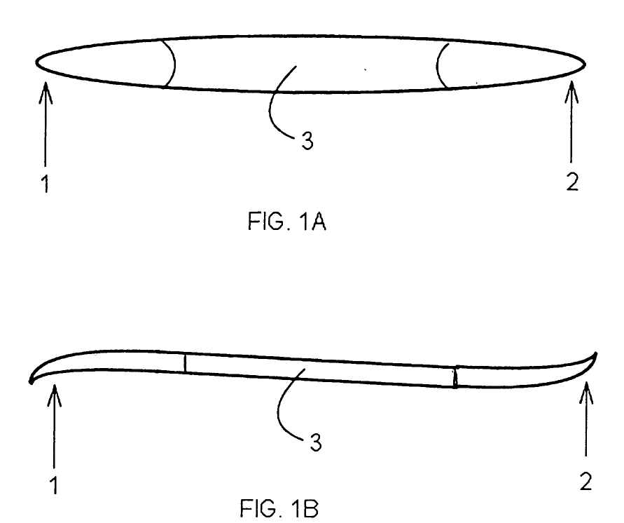

Referring to FIG. 1 as a non-limiting example of a commonly used tire lever, the lever comprises a first lever end portion 1, a second lever end portion 2 and a lever body 3 connecting the first and second lever end portions. The first lever end portion 1 and the second lever end portion 2 are the same shape and size, or alternatively are different shapes and/or sizes. For example, in certain embodiments it is contemplated that that the first lever end portion I engages a tire bead and the second lever end portion 2 engages a tire bead, wherein the first and second lever end portions are the same size and/or shape or a different size and/or shape, or any combination thereof. Thus, a non-marring tire tool of the invention comprises a lever, wherein the lever has a first lever end portion, a second lever end portion and a lever body connecting the first and second end portion and a non-marring polymer coating.

A non-marring tire tool of the invention further comprises additional lever end portions, for example, a third lever end portion, a fourth lever end portion, etc. In certain embodiments, the additional lever ends are spaced equidistant on the tire tool relative to the first and second lever end portions (e.g., a tire tool having four equidistant lever end portions has a cross shape). In certain other embodiments, a non-marring tire tool of the invention comprises two lever end portions or three lever end portions or four lever end portions, each lever end being a different size and/or shape, thereby being useful in engaging tire beads of varying size tires and/or wheel rim materials. In other embodiments, the additional lever end portions are spaced in a non-equidistant configuration (e.g., a rake or a fork configuration; See U.S. Pat. No. 5,265,661, incorporated herein by reference in its entirety). The various tire tool lever end configurations contemplated in the present invention are well known to one of skill in the art.

The following example describes the “general” steps for removing a tire from a wheel rim using a tire tool. This example should not be construed as limiting the scope of the present invention, as there are many variations to these general steps and these steps are readily known to a person of skill in the art.

Thus, to remove a tire from a wheel rim, a working end of a tire tool is inserted between the tire bead and the wheel rim flange. The user applies pressure to the opposite handle end of the tire tool, using the tire tool as a lever and the wheel rim as a fulcrum. A short length of the tire bead is lifted axially over the wheel rim flange. This process is repeated in successive stages to increase the length of the bead on the axial outside of the wheel rim flange while more of the tire bead is pried over the wheel rim flange. After the first bead is broken, the second tire bead is broken as described above and the tire is then stripped from the rim of the wheel. For installing a tire on a wheel rim, the foregoing process is carried out in reverse order.

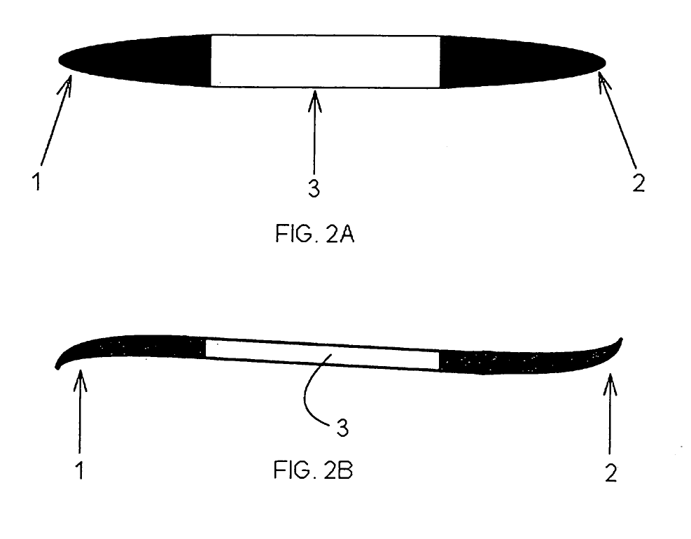

As described above, the wheel rim serves as a fulcrum for the tire tool, such that the tire tool lifts a short length of the tire bead over the wheel rim flange. Thus, one aspect of a non-marring polymer coating of the invention is that the polymer cover the entire surface area of at least a lever end portion of tire tool (e.g., see FIG. 2A and FIG. 2B) which contacts the wheel rim.

As a non-limiting example, assume a tire tool has overall dimensions of 25 cm length, 2.5 cm width and 0.1 cm thickness, wherein the total length (25 cm) comprises a first lever end portion of 10 cm, a second lever end portion of 10 cm, and a lever body of 5 cm, which connects the first and second lever end portions. Thus, in this example, for a non-marring polymer coating to cover the entire surface area of at least a lever end portion of tire tool (e.g., the first lever end portion of 10 cm length), the non-marring polymer coating must cover about 25.2 cm² of the first lever end portion. Alternatively, in the example above, the non-marring polymer coating covers (a) the entire surface area of the first lever end portion and (b) the entire surface area of the second lever end portion; and optionally covers (c) the entire surface area of the lever body connecting the first and second lever ends, such that the entire surface area of the tire tool is coated with the non-mar polymer (e.g., the polymer covers the entirety of the tire tool).

A tire tool of the invention comprises any material suitable to withstand the forces needed to engage a tire bead, and/or lever a tire bead and/or pry a tire bead away from a wheel rim. Materials such as steel, stainless steel, hardened alloy steel, forged steel, chrome plated steel, chrome-vanadium steel, hardened forged aluminum alloy, magnesium and titanium are exemplary choices for tire tool materials, as they are durable, rarely break and known in the art to withstand the forces required to mount and/or disengage a tire from its wheel rim.

### B. THE NON-MARRING COATING

It is known in the art, that a common event in the process of removing a tire from a wheel rim is a marring of the wheel rim and/or damage of the tire side wall and/or damage of the tire bead. It is also known in the art, that during the process of removing a tire from a wheel rim the tire bead and/or the side wall is torn or punctured by the tire tool. To avoid wheel rim marring, it is desirable to reduce the frictional/abrasive characteristics of the tire tool and/or increase the lubricious characteristics of the tire tool, thereby reducing the damaging effects of contact between the tire tool and the wheel rim. The non-marring polymers of the invention (set forth below) comprise at least one of the following characteristics, all of which are contemplated to reduce the damaging effects of metal on metal contact (or metal on carbon fiber contact, etc.) between the tire tool and the wheel rim: (1) the polymer provides a “protective” barrier between the tire tool and the wheel rim; (2) the polymer reduces frictional/abrasive characteristics of the tire tool; (3) the polymer increases the lubricious characteristics of the tire tool; (4) the polymer is impact resistant; (5) the polymer has a melting temperature (Tₘ) greater than about 100° F. (e.g., see Table 2); (6) the polymer has a Rockwell R hardness greater than about R35 or a Shore D hardness greater than about D30 or a Shore A hardness greater than about A85 (e.g., see Table 3) and/or (7) the polymer has a low coefficient of friction (e.g., a coefficient of friction less than about 1.0).

Thus, the present invention provides a tire tool comprising a non-marring polymer coating, such that the polymer coating reduces or prevents marring, damaging or disfiguring of a wheel rim during the tire mounting or dismounting process. As defined hereinafter, the terms “mar” and “marring” are used interchangeably, and encompass any type of wheel rim mar, wheel rim scratch, wheel rim damage or wheel rim disfiguration that results in the process of engaging a tire bead.

Polymers are often classified as either biological polymers or industrial polymers. Biological polymers consist of polymers such as polysaccharides, deoxyribonucleic acids (DNA), polypeptides, lipids and the like. Industrial polymers are typically grouped into five classes: (1) “plastics” (thermoplastics and thermosets), (2) “elastomers” (natural and synthetics rubbers), (3) “man-made fibers”, (4) “adhesives” and (5) “surface coatings”. More recently a sixth industrial polymer class, known as “thermoplastic elastomers”, has been added.

A non-marring polymer of the invention is typically classified as an industrial polymer. More specifically, a non-marring polymer of the invention is a “plastic” or a polymer composition which behaves as a “plastic” polymer, the properties of which are set forth below. In general, plastic polymers have the capability of being molded or shaped, usually by application of heat and/or pressure. In contrast, a non-marring polymer of the invention is not an “elastomeric polymer” (or “elastomer”) or a polymer which behaves as an “elastomer”, the properties of which are set forth below. Plastics and elastomers are well known and readily distinguished in the polymer arts.

“Adhesives” are generally defined as any substance that is capable of holding materials together in a functional manner by surface attachment that resists separation. Adhesive as a general term includes cement, mucilage, glue and paste, terms that are often used interchangeably for any organic material that forms an adhesive bond.

“Man-made fibers” are spun and woven into a huge number industrial products. The polymers from which man-made fibers are produced are characterized by long, chainlike molecules of great size and molecular weight. Many man-made fibers comprise the same, or similar compounds that make up plastics. In certain embodiments, it is contemplated that man-made fibers are added to a plastic formulation to modulate one or more mechanical properties of a plastic polymer of the invention.

A “surface coating” is any mixture of film-forming materials which, when applied to a surface and cured or dried, yields a functional thin film that. Most surface coatings employed in industry are based on synthetic polymers, and as such, the terms “surface coating” and “plastic” will often overlap. As defined hereinafter, the term “surface coating” is interchangeable with the terms “plastic”, “plastic polymer” or “plastic coating”, as long as the “surface coating” is formulated with a plastic or has functional properties of a “plastic”.

Thus, a non-marring polymer of the invention is a plastic polymer. Plastic polymers have the capability of being molded or shaped, usually by application of heat and/or pressure. Plastics are most often defined on the basis of their behavior. More specifically, plastics are defined hereinafter as either “thermoplastic” resins or “thermosetting” resins. Thermoplastics (e.g., polyethylene and polystyrene) are capable of being molded and remolded repeatedly. The polymer structure associated with thermoplastics is that of individual molecules that are separate from one another and flow past one another. Thermoplastic molecules have molecular weights (M_{w}) ranging from low to extremely high, and they are branched or linear in structure, but the common feature is that of separability and consequent mobility. Thermosets, in contrast, cannot be reprocessed upon reheating. During their initial processing, thermosetting resins (e.g., epoxies and phenolics) undergo a chemical reaction that results in an infusible, insoluble network. Essentially, the entire heated, finished thermoset article becomes one large molecule (e.g., a network polymer or a cross-linked polymer).

The plastic behavior of polymers is also influenced by their morphology or arrangement of molecules on a macro scale. Plastic polymer morphologies are either amorphous or crystalline. Amorphous molecules are arranged randomly and are intertwined, whereas crystalline molecules are closely packed and in a discernible order. Most thermosets are amorphous, while thermoplastics are amorphous or semicrystalline. Semicrystalline materials display crystalline regions, called crystallites, within an amorphous matrix.

By definition, thermoplastic materials retain their molded shapes up to a certain temperature, which is set by the glass transition temperature (T_{g}) or the melting temperature (Tₘ) of the particular polymer. For example, below the T_{g} the molecules of a polymer material are frozen in what is known as the glassy state, wherein there is little or no movement of molecules past one another, and the material is stiff. Above the T_{g}, the amorphous parts of the polymer enter the rubbery state, in which the molecules display increased mobility and the material becomes plastic and/or rubbery. In the case of noncrystalline polymers such as polystyrene, raising the temperature further leads directly to the liquid state. On the other hand, for partly crystalline polymers such as low-density polyethylene or polyethylene terephthalate, the liquid state is not reached until the melting temperature (Tₘ) is passed. Beyond this point the crystalline regions are no longer stable, and the liquid polymers are molded or extruded. For example, in high-density polyethylene, the long sequences of ethylene units that make up the polymer spontaneously crystallize at temperatures below about 265° F., so that, at normal temperatures (e.g., about 68° F.) polyethylene is a partially crystalline plastic solid. Polypropylene crystallites (or crystallized regions) do not melt until they are heated to about 350° F. Thermosets, which do not melt upon reheating, are dimensionally stable up to a temperature at which chemical degradation begins. Listed in the first and second rows of Table 3-A through Table 3-D are the Tₘ and/or T_{g} of various plastics.

In contrast to plastic polymers, an “elastomeric polymer” (or “elastomer”) is defined hereinafter as a rubbery material composed of long, chainlike molecules that are capable of recovering their original shape after being stretched to great extents. Under normal (relaxed) conditions, the long molecules making up an elastomeric material are irregularly coiled. However, with the application of force the molecules straighten out in the direction in which they are being pulled. Upon release, the molecules spontaneously return to their normal compact, random arrangement.

Thus, elastomers are highly flexible, whereas plastic polymers are rather stiff and inflexible. Table 3-A through Table 3-D list the physical and mechanical properties of several plastics (i.e., thermoplastics and thermosets). Similarly, Table 3-E through Table 3-F list the physical and mechanical properties of several rubbers (i.e., elastomers).

Four common elastomers are cis-polyisoprene (natural rubber), cis-polybutadiene (butadiene rubber), styrene-butadiene rubber and ethylene-propylene monomer. The elastomeric polymers of cis-polyisoprene and cis-polybutadiene have a Tₘ of about 75° F. and 40° F., respectively. In addition, the T_{g} of all these polymers are quite low, well below 68° F. (i.e., room temperature), so that all of them are soft, highly flexible, and elastic at ambient temperatures. Other elastomers well known in the polymer arts include acrylic rubber (alkyl acrylate copolymer), butyl rubber (isobutylene-isoprene copolymer), epichlorhydrin, hydrogenated nitrile rubber, isoprene rubber (synthetic cis-polyisoprene), nitrile rubber (acrylonitrile-butadiene copolymer) and silicone rubber.

In addition to their Tₘ and/or T_{g}, plastic and elastomeric polymers are often differentiated by hardness. The hardness testing of plastics is most commonly measured by the Shore test or Rockwell hardness test. Both methods measure the resistance of plastics toward indentation and provide an empirical hardness value. Shore Hardness, using either the Shore A or Shore D scale, is the preferred method for rubbers/elastomers and is also commonly used for “softer” plastics. The Shore A scale is used for “softer” rubbers while the Shore D scale is used for “harder” ones. The Rockwell R scale is most commonly used for “hard” plastics. The high end of the Shore A scale overlaps with the low end of the Shore D scale (Table 1), so as to provide an approximate continuity between the two scales.

TABLE 1
SHORE A AND SHORE D HARDNESS
EQUIVALENCY CHART

```
100A ≅ 75D
  95A ≅ 50D
  90A ≅ 40D
  85A ≅ 32D
```

The soft and rubbery property of an elastomer is not a desired feature of a non-marring polymer, and as such, a non-marring polymer of the invention is a plastic polymer or a polymer composition which physically behaves (or performs) as a plastic. For example, a tire tool coated with an elastomer will tend to “grab” or “stick” to the rubber tire bead and/or the wheel rim, making it difficult for the tool to move around the circumference of the rim flange. Further, elastomeric materials, due to their softness (e.g., see Table 2) and high coefficient of friction, will rip and/or tear away from the tire tool during the tire mounting (or dismounting) process.

Although a non-marring polymer of the invention is defined as a plastic, the non-marring polymer composition or formulation may comprise one or more elastomeric polymers, as long as the final polymer formulation or polymer end product behaves (or performs) as a plastic (e.g., the polymer has Tₘ and/or T_{g} similar to a plastic and/or a hardness value similar to a plastic).

TABLE 2
Comparison of Shore A, Shore D and Rockwell R Hardness Scales

| ELASTOMER/RUBBER | HARDNESS SCALE | | | |
|---|---|---|---|---|
| POLYMERS | SHORE A | SHORE D | ROCKWELL R | PLASTIC POLYMERS |
| | | | 150 | Phenolic |
| | | | 140 | |
| | | | 130 | Polymethylmethacrylate |
| | | | | (Acrylic) |
| | | | 120 | Polycarbonate/ABS alloy |
| | | | 110 | Polymethacrylate Butadiene |
| | | | | Styrene; PVC |
| | | 80 | 100 | Nylon |
| | | | 95 | |
| | 100 | | 90 | Polystyrene |
| | | 70 | 85 | Polypropylene |
| | | | 80 | |
| | | | 75 | High Density Polyethylene |
| | | | 70 | |
| | | 60 | 65 | Tetrafluoroethylene (Teflon ®) |
| | | | 60 | Thermoplastic Polyurethane |
| | | | 55 | Ultra High Mw Polyethylene |
| | 95 | 50 | 50 | Low Density Polyethylene |
| | | | 40 | Polybutylene; Ionomers |
| | 90 | 40 | | |
| | 85 | 30 | | |
| Styrene-Butadiene | | | | |
| Tire Tread Rubber | 70 | | | |
| Butyl Rubber | 60 | | | |
| Polyisoprene (Rubber) | | | | |
| Nitrile Rubber | 50 | | | |
| Methylphenyl Silicone Rubber | | | | |
| Ethylene Propylene Rubber | 40 | | | |
| | 30 | | | |
| Rubber Bands | | | | |
| Polychloroprene (Neoprene) | 20 | | | |

TABLE 3-A
PHYSICAL PROPERTIES OF PLASTICS AND RUBBERS
Thermoplastics

| Physical | | Polyamide- | Low Density | Ultra High M_{w} | Polycarbonate | |
|---|---|---|---|---|---|---|
| Properties | Polybutylene | Imide | Polyethylene | Polyethylene | ABS Alloy | Polypropylene |
| Melting Temp. | 255° F. | ND | 230° F. | 280° F. | 482° F. | 350° F. |
| (Tm) | | | | | | |
| Glass Transition | ND | 527° F. | −40° F. | ND | ND | −4° F. |
| Temp. (Tg) | | | | | | |
| Elongation % | 350 | 5 | 515 | 15 | 100 | 200 |
| Tensile Strength | 5000 psi | 18000 psi | 1943 psi | 5800 psi | 750 psi | 4500 psi |
| Dynamic | ND | 0.30 | ND | 0.12 | ND | ND |
| Coefficient of | | | | | | |
| Friction | | | | | | |
| Static Coefficient | ND | ND | ND | 0.20 | ND | ND |
| of Friction | | | | | | |
| Rockwell | R40 | R120 | ND | R55 | R116 | R95 |
| Hardness | | | | | | |
| Shore D Hardness | ND | D90 | D55 | D67 | ND | ND |
| Shore A Hardness | ND | ND | ND | ND | ND | ND |

ND = Not Determined
Dynamic and Static Coefficient of Friction measured against steel.

TABLE 3-B
PHYSICAL PROPERTIES OF PLASTICS AND RUBBERS
Thermoplastics

| | | Polymethyl- | | | | |
|---|---|---|---|---|---|---|
| | Polymethyl- | Methacrylate | | | | Polyvinylidene |
| | Methacrylate | Butadiene | Polyvinyl | Polyamide | Thermoplastic | Fluoride |
| Physical Properties | (Acrylic) | Styrene | Chloride (PVC) | (Nylon 6,6) | Polyurethane | (PVDF) |
| Melting Temp. | 160° F. | ND | 520° F. | 505° F. | 284° F. | 310° F. |
| (Tm) | | | | | | |
| Glass Transition | 212° F. | 212° F. | 180° F. | 125° F. | ND | −40° F. |
| Temp. (Tg) | | | | | | |
| Elongation % | 48 | 20 | 7.5 | 150 | 500 | ND |
| Tensile Strength | 7000 psi | 7200 psi | 8700 | 7600 psi | 5800 psi | 8700 psi |
| Dynamic | ND | ND | 0.39 | ND | ND | ND |
| Coefficient of | | | | | | |
| Friction | | | | | | |
| Static Coefficient of | 0.40 | ND | 0.34 | ND | ND | ND |
| Friction | | | | | | |
| Rockwell Hardness | R120 | R110 | R110 | R110 | R60 | R110 |
| Shore D Hardness | ND | ND | ND | ND | ND | D80 |
| Shore A Hardness | ND | ND | ND | ND | ND | ND |

ND = Not Determined
Dynamic and Static Coefficient of Friction measured against steel.

TABLE 3-C
PHYSICAL PROPERTIES OF PLASTICS AND RUBBERS
Thermoplastics

| | | | | | Polyester-semi- | |
|---|---|---|---|---|---|---|
| | Acetal | Polyether- | Polyphenyl | | crystalline | |
| Physical | homopolymer/ | etherketone | Sulfone | Polyether | thermoplastic | Polybenzimidazole |
| Properties | PTFE-filled | (PEEK) | (PPS) | Imide (PEI) | (PET) | (PBI) |
| Melting Temp. | 350° F. | 644 | ND | ND | 491° F. | ND |
| (Tm) | | | | | | |
| Glass Transition | ND | ND | 428° F. | 420° F. | ND | 750° F. |
| Temp. (Tg) | | | | | | |
| Elongation % | 15 | 10 | 30 | 80 | 20 | 3 |
| Tensile Strength | 8000 psi | 15000 psi | 1100 psi | 16500 psi | 12400 psi | 20000 psi |
| Dynamic | 0.19 | 0.40 | ND | 0.42 | 0.20 | 0.24 |
| Coefficient of | | | | | | |
| Friction | | | | | | |
| Static Coefficient | ND | ND | ND | ND | ND | ND |
| of Friction | | | | | | |
| Rockwell R | R115 | R126 | R120 | R125 | R125 | ND |
| Hardness | | | | | | |
| Shore D Hardness | D83 | D85 | D80 | D86 | D87 | D94 |
| Shore A Hardness | ND | ND | ND | ND | ND | ND |

ND = Not Determined
Dynamic and Static Coefficient of Friction measured against steel.

TABLE 3-D
PHYSICAL PROPERTIES OF PLASTICS AND RUBBERS

| Thermoplastics | | | | |
|---|---|---|---|---|
| | | Tetrafluoroethylene | | |
| | | perfluoromethylvinyl | | Ionomers |
| | Polytetrafluoroethylene | ether copolymer | Polymethylmethacrylate/ | Ethylene/Methacrylic |
| Physical Properties | (Teflon ®) | (PFA) | PVC alloy (Kydex ®) | Acid (Surlyn ®) |
| Melting Temp. | 620° F. | 572° F. | ND | 195° F. |
| (Tm) | | | | |
| Glass Transition | 260° F. | 10° F. | 195° F. | ND |
| Temp. (Tg) | | | | |
| Elongation % | 200 | ND | ND | 400 |
| Tensile Strength | 4060 psi | 4205 psi | 58000 psi | 4000 psi |
| Dynamic* | ND | 0.09 | ND | ND |
| Coefficient of | | | | |
| Friction | | | | |
| Static* Coefficient | 0.05 | 0.10 | ND | ND |
| of Friction | | | | |
| Rockwell Hardness | ND | ND | R105 | R40 |
| Shore D Hardness | D50-65 | D60 | ND | ND |
| Shore A Hardness | ND | ND | ND | ND |

ND = Not Determined
Dynamic and Static Coefficient of Friction measured against steel.

TABLE 3-E
PHYSICAL PROPERTIES OF PLASTICS AND RUBBERS
Elastomers (Rubbers)

| | | | | Poly(butyl 2- | |
|---|---|---|---|---|---|
| | Polyisoprene | Polybutadiene | Ethylene- | propenoate) | Styrene- |
| | (Natural | (Butadiene | propylene-diene | (PolybutylAcrylate | Butadiene |
| Physical Properties | Rubber) | Rubber) | (EPDM) Rubber | Rubber) | copolymer |
| Melting Temp. | 95° F. | 35° F. | ND | 117° F. | ND |
| (Tm) | | | | | |
| Glass Transition | −103° F. | −148° F. | ND | −45° F. | −67° F. |
| Temp. (Tg) | | | | | |
| Elongation % | 650-900 | ND | 500 | ND | 600 |
| Tensile Strength | 725 psi | ND | 1450 psi | ND | 2175 psi |
| Dynamic | ND | ND | 3.10 | ND | ND |
| Coefficient of | | | | | |
| Friction | | | | | |
| Static Coefficient of | ND | ND | ND | ND | 1.5-2.0 |
| Friction | | | | | |
| Rockwell-R | ND | ND | ND | ND | ND |
| Hardness | | | | | |
| Shore D Hardness | ND | ND | ND | ND | ND |
| Shore A Hardness | A55 | ND | 48 | ND | A40-90 |

ND = Not Determined
Dynamic and Static Coefficient of Friction measured against steel.

TABLE 3-F
PHYSICAL PROPERTIES OF PLASTICS AND RUBBERS
Elastomers (Rubbers)

| | | | Acrylonitrile- | | |
|---|---|---|---|---|---|
| | Ethylene | Polyisobutylene- | Butadiene | | Methylphenyl |
| | Propylene | co-isoprene (Butyl | copolymer | Polychloroprene | Silicone |
| Physical Properties | Rubber | Rubber) | (Nitrile Rubber) | (e.g., Neoprene ®) | rubber |
| Melting Temp. | ND | 35° F. | ND | 85° F. | −108° F. |
| (Tm) | | | | | |
| Glass Transition | −75° F. | −96° F. | −40° F. | −10° F. | −170° F. |
| Temp. (Tg) | | | | | |
| Elongation % | 600 | 850 | 650 | 4000 | ND |
| Tensile Strength | 3000 psi | 2610 psi | 3000 psi | 715 psi | 870 psi |
| Dynamic | ND | ND | ND | 2.20 | ND |
| Coefficient of | | | | | |
| Friction | | | | | |
| Static Coefficient of | ND | ND | ND | ND | ND |
| Friction | | | | | |
| Rockwell-R | ND | ND | ND | ND | ND |
| Hardness | | | | | |
| Shore D Hardness | ND | ND | ND | ND¹ | ND |
| Shore A Hardness | A35-90 | A40-60 | A50-90 | A15-90 | A50 |

ND = Not Determined
ND¹= When polymerized at 131° F. required 2 months for hardening.
Dynamic and Static Coefficient of Friction measured against steel.

Thus, a non-marring tire tool of the invention comprises a plastic polymer. In certain embodiments, a plastic polymer of the invention comprises, but is not limited to, one or more of the following polymers (or polymer starting materials): polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde, and a vinyl acetate, a co-polymer thereof, a polymer blend thereof or any combination thereof.

In another embodiment of the invention, a non-marring polymer comprises any polymer composition which behaves or performs as a plastic, wherein the polymer does not behave or perform as an elastomer; as long as the polymer protects a wheel rim from damage when contacted with a tire tool (i.e., the tire tool engages a tire bead). In certain embodiments, a non-marring plastic polymer of the invention is a “permanent” plastic polymer. In other embodiments, a non-marring plastic polymer of the invention is a “non-permanent” plastic polymer. As defined hereinafter, the terms “permanent” plastic polymer and “non-permanent” plastic polymer both refer to a plastic polymer or plastic polymer coating of the invention (e.g., a plastic comprising one or more polymers(or polymer starting materials set forth below). A “non-permanent” plastic polymer differs from a “permanent” plastic polymer in that the “non-permanent” plastic is removed from, or added to, the tire tool.

As defined hereinafter, a “non-permanent” plastic polymer of the invention is referred to as a “sheath”, wherein a sheath comprises one or more of the polymers set forth below. Thus, a “sheath” or a “removable sheath” is any non-permanent polymer and encompasses terms including, but not limited to, a sheath, a case, a jacket, a cover, a covering, and the like. In certain embodiments, a sheath comprises Kevlar® blended or admixed with one or more polymers set forth below. In certain other embodiments, a sheath comprises a polyacrylic/polyvinyl chloride (PVC) polymer blend known as Kydex®. In other embodiments, a sheath comprises an ionomer resin such as Surlyn®, Nucrel® or a combination thereof. In other embodiments, a sheath is a nylon polymer. In yet other embodiments, a sheath is a polyvinylidene fluoride co-polymer. A preferred sheath composition of the invention comprises a plastic polymer or polymer blend which will not readily tear or rip during the tire mounting or dismounting process. In certain preferred embodiments, the plastic sheath is a thermoplastic, a cross-linked thermoplastic or a thermoset.

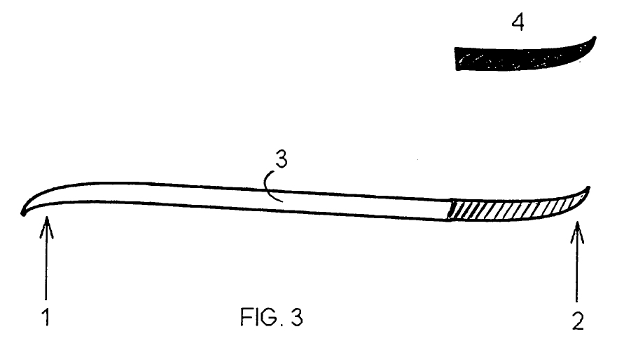

A sheath of the invention is never fixed or secured to the tire lever by a fastening means such as screws, rivets, dowels and the like. The plastic polymer of a sheath is pre-formed (e.g., by thermoforming the polymer) to the fit precisely over a particular tire tool shape or lever end configuration. Referring to FIG. 3, the sheath 4 is a preformed non-marring polymer which fits onto and completely covers a lever end 2 of the tire tool.

In certain embodiments, a sheath is placed over or slid onto a tire tool comprising a permanent polymer coating (FIG. 3). Thus, in the event that the permanent polymer coating of the tire tool is damaged or if a different plastic polymer composition is needed for a particular wheel rim composition (e.g., having reduced friction or an increased abrasion resistance), a sheath is slid onto the lever end, such that the tire tool is used to engage a tire bead, without marring or disfiguring of a wheel rim.

In contrast, a “permanent” plastic polymer (or plastic coating) of the invention is physically or chemically fixed or bound to the tire tool, such that the permanent plastic coating is not removable from the tire tool. Stated another way, a permanent non-marring plastic coating is not secured to the tire lever by a fastening means such as screws, rivets, dowels and the like. A permanent non-marring polymer coating of the invention is permanently bonded to the tire tool during a polymer forming or coating process such as thermoforming, thermosetting, electrostatic coating (e.g., powder coating), heat curing (e.g., oven baking), chemical curing (e.g., catalytic cross-linking), spraying, brushing, dipping, fluid bed dipping, injection molding, extrusion molding and the like. A permanent polymer composition of the invention comprises a plastic polymer or polymer blend having a plastic property, wherein the plastic polymer will not readily tear or rip away from the tire lever during the mounting or dismounting process. In certain embodiments, a plastic polymer is a thermoplastic, a cross-linked thermoplastic or a thermoset. As described supra, a thermoset material is “cured” or polymerized using heat and pressure, or as with epoxies a chemical reaction started by a chemical initiator. For example, thermoset polymers include, but are not limited to phenolics, epoxies, polycarbonates, polydicyclopentadienes and melamines.

Thus, a non-marring tire tool of the invention comprises a permanent non-marring plastic coating and optionally comprises a non-marring plastic sheath. In certain embodiments, a non-mar polymer of the invention comprises, but is not limited to, one or more of the following polymers (or polymer starting materials): a polyisocyanate, a polyurethane, a polyester, a polyethylene, an ultra high molecular weight polyethylene (UHMWPE), a polybutylene, a polypropylene, a plastisol, a polyacrylic, a polyether ketone, a polyphenyl sulfone, a polyvinyl, a polyvinylidene, a silicone, a polyisoprene, an epoxy, a polychloroprene, a polyether imide, a polybenzimidazole, a polycarbonate, a polycarbonate/acetonitrile-butadiene-styrene (ABS) alloy, a fluoropolymer, an ionomer resin, a polyamide, a polyimide, a polyamideimide, a vinyl acetate, a co-polymer thereof, a polymer blend thereof or any combination thereof.

The following non-limiting list of polymers are divided into (1) carbon-carbon chain polymers (also called vinyls) and (2) heterochain polymers (also called non-vinyls). As defined herein, a “homopolymer” is a polymer made out of a single monomer species. A “copolymer” is a polymer made from more than one kind of monomer, that is, made out of two or more comonomers In contrast, a “polymer alloy” or “polymer blend” is a polymer mixture made by combining two or more polymer resins. A “block copolymer” is a copolymer in which the comonomers are separated into long sections of the polymer backbone chain.

### 1. Carbon-Carbon Chain Polymers (Vinyl Polymers)

In carbon-chain polymers, as the name implies, the backbones are composed of linkages between carbon atoms. The carbon-carbon chain polymers are also referred to as vinyls, as they typically contain the hydrocarbon vinyl group (CH₂═CH—).

### a. Polyolefins

A large portion of industrial plastic polymers are polymerized olefins (polyolefins). Olefins are hydrocarbons whose molecules contain a pair of carbon atoms linked together by a double bond. Polyolefins include, but are not limited to, ethylene, propylene, and butylene. Olefin molecules are commonly represented by the chemical formula CH₂═CHR, with the R group representing an atom or pendant molecular group of varying composition. The composition and structure of the R group determines which of the huge array of possible properties will be demonstrated by the polymer.

### i. Polyethylenes

Ethylene, commonly produced by the cracking of ethane gas, forms the basis for the largest single class of plastics, the polyethylenes. An ethylene monomer has the chemical composition CH₂═CH₂; as the repeating unit of polyethylene. Polyethylene is produced in linear or branched forms. Branched versions are known as low-density polyethylene (LDPE) or linear low-density polyethylene (LLDPE); the linear versions are known as high-density polyethylene (HDPE) and ultrahigh molecular weight polyethylene (UHMWPE).

HDPE a linear polymer, which allows the polymer chains to pack closely together, resulting in a dense, highly crystalline material of high strength and moderate stiffness. Uses include blow-molded bottles for milk and household cleaners and injection-molded pails, bottle caps, appliance housings, and toys.

UHMWPE is made with molecular weights of three million to six million atomic units, as opposed to 500,000 atomic units for HDPE. These polymers can be spun into fibres and drawn, or stretched, into a highly crystalline state, resulting in high stiffness and a tensile strength many times that of steel.

Thus, in certain embodiments of the invention, a non-marring plastic is a polyethylene. In one embodiment, a polyethylene is a UHMWPE such as UHMWPEs known as Tivar® and Tivar® DrySlide (Poly Hi Solidur, Inc., Fort Wayne, Ind.). In other embodiments, a polyethylene is a HPDE, for example, a HPDE known as Sanalite® (Poly Hi Solidur, Inc., Fort Wayne, Ind.).

In another embodiment of the invention, a non-marring plastic is a polyethylene blend. For example, U.S. Pat. No. 4,007,298, incorporated herein by reference in its entirety, sets forth blends of HDPE and LDPE exhibiting “tenacious adhesion” to ferrous metals. U.S. Pat. No. 6,596,815, incorporated herein by reference in its entirety, describes thermoplastic blends of ionomer/HDPE with improved flow characteristics (i.e., reduced viscosity), without significantly degrading physical properties such as impact resistance and tensile strength.

### ii. Polypropylenes

Polypropylene is a highly crystalline thermoplastic resin, built up by the chain-growth polymerization of propylene (CH₂═CHCH₃). Polypropylene shares some of the properties of polyethylene, but it is stiffer and has a higher Tₘ. As a plastic, polypropylene is blow-molded into bottles for foods, shampoos, and other household liquids. It is also injection-molded into many products, such as appliance housings, dishwasher-proof food containers, toys, automobile battery casings, and outdoor furniture. When a thin section of molded polypropylene is flexed repeatedly, a molecular structure is formed that is capable of withstanding much additional flexing without failing. This fatigue resistance has led to the design of polypropylene boxes and other containers with self-hinged covers.

In certain embodiments, a non-marring plastic of the invention is a polypropylene. In certain embodiments, the polypropylene is propylene homopolymer.

### iii. Polystyrenes

Polystyrene is a rigid, relatively brittle thermoplastic resin, polymerized from styrene (CH₂═CHC₆H₅). Styrene, also known as phenylethylene, is obtained by reacting ethylene with benzene in the presence of aluminum chloride to yield ethylbenzene, which is then dehydrogenated to yield clear, liquid styrene.

The presence of the pendant phenyl (C₆H₅) group is key to the properties of polystyrene. The phenyl groups prevent the polymer chains from packing into a close, crystalline arrangement, so that solid polystyrene is transparent. In addition, the phenyl rings restrict rotation of the chains around the carbon-carbon bonds, thus lending the polymer its noted rigidity.

Foamed polystyrene is made into insulation, packaging, and food containers such as beverage cups, egg cartons, and disposable plates and trays. Solid polystyrene products include injection-molded eating utensils, audiocassette holders, and cases for packaging compact discs. More than half of all polystyrene produced is blended with five to ten percent polybutadiene to reduce brittleness and improve impact strength. This blend is marketed as high-impact polystyrene.

### iv. Polyvinyl Chloride (PVC)

Second only to polyethylene in production and consumption, PVC is manufactured by bulk, solution, suspension, and emulsion polymerization of vinyl chloride monomer (CH₂═CHCl), using free-radical initiators. Pure PVC is rigid and has low flammability PVC is often blended with a plasticizer (sometimes in concentrations as high as fifty percent) to reduce its rigidity.

Thus, in certain embodiments of the invention, a non-marring plastic polymer is a PVC, for example, a type 1, grade 1 PCV. Described below in Example 7, are general formulations of PVC. In certain other embodiments, a non-marring plastic is a PVC/acrylic blend. U.S. Pat. No. 4,113,681, incorporated herein by reference in, its entirety, describes a thermoplastic powder comprising a blend of a vinyl chloride/vinyl acetate/maleic acid terpolymer, an acrylic polymer and an ester plasticizer, wherein the thermoplastic powder is useful as a finish for metals such as tubing, wires, fence posts, lawn furniture, play equipment and the like.

### v. Polyvinylidene Chloride (PVDC)

Vinylidene chloride (CH₂═CCl)₂, is made directly from ethylene and chlorine or by the further chlorination of vinyl chloride with subsequent removal of hydrogen chloride by alkali treatment. It is polymerized in suspension or emulsion processes, using free-radical initiators. In certain embodiments of the invention, a non-marring plastic formulation comprises a PVDC.

### vi. Polyvinyl Acetate (PVAC)

The monomer vinyl acetate (CH₂═CHO₂CCH₃) is prepared from ethylene by reaction with oxygen and acetic acid over a palladium catalyst and is polymerized with free-radical initiators. In certain embodiments of the invention, a non-marring plastic formulation comprises a PVAC, a blend thereof or a co-polymer thereof.

### b. Acrylics

Acrylates are a family of polymers made from acrylate monomers, wherein the acrylate monomers are esters which contain vinyl groups. Some acrylates have an extra methyl group attached to the alpha carbon, and these are called methacrylates. One of the most common methacrylate polymers is poly(methyl methacrylate). Poly(methyl acrylate) is a white rubber at room temperature, whereas poly(methyl methacrylate) is a strong, hard, and clear plastic at room temperature.

Poly(acrylic acid) is a polyelectrolyte, such that each repeat unit has an ionizable carboxylic acid group. There are several derivatives of polyacrylates which contain nitrogen, e.g., polyacrylamide and polyacrylonitrile. Polyacrylonitrile is used to make acrylic fibers.

Thus, in certain embodiments, a non-marring plastic of the invention is an acrylic or a polyacrylic. For example, U.S. Pat. No. 6,146,473, incorporated herein by reference in its entirety, describes an acrylic resin for coating a metal surface, wherein the resin has improved corrosion resistance, adhesion and slip properties (i.e., “lubricity”).

### i. Polymethyl Methacrylate (PMMA)

Methyl methacrylate is polymerized in bulk or suspension methods using free-radical initiators. The presence of a pendant methyl (CH₃) group prevents the polymer chains from packing closely in a crystalline fashion and from rotating freely around the carbon-carbon bonds. As a result, PMMA is a transparent and rigid plastic; often used as a substitute for glass. PMMA is also employed in domed skylights, swimming pool enclosures, aircraft canopies, instrument panels, and luminous ceilings. For these applications the plastic is sold in the form of sheets that are machined or thermoformed, but it is also injection-molded into headlights and taillights and lighting-fixture covers. In certain embodiments of the invention a non-marring plastic is PMMA.

### ii. Polyacrylate Elastomers

Acrylic esters, copolymerized with small amounts (approximately five percent) of another monomer containing a reactive halogen, can form polymer chains that inter link at the halogen sites. These so-called polyacrylate elastomers display good heat resistance (almost as good as silicone rubbers and fluoroelastomers) and resistance to swelling by hydrocarbon oils. They are mainly used for O-rings, seals, and gaskets. In one embodiment of the invention, a polyacrylate elastomer is blended or formulated with one or more additional polymers, such that the final polymer composition physically and/or mechanically performs as a plastic.

### c. Fluorinated Polymers (Fluoropolymers)

In other embodiments, a non-mar polymer of the invention is a fluoropolymer (e.g., a fluoropolymer sold under the name Teflon®; DuPont® Wilmington, Del.), particularly a polytetrafluoroethylene (PTFE), a perfluoroalkoxy (PFA), a fluorinated ethylene propylene (FEP), an ethylene tetrafluoroethylene (ETFE) or a blend of one or more of a PTFE, a PFA, a FEP and a ETFE. Fluoropolymers are inert to virtually all chemicals, are extremely durable, are abrasion resistant and are considered the most slippery (lubricous) material in existence. For example, U.S. Pat. Nos. 5,168,107, 4,596,839, 4,049,863 and 4,087,394, each incorporated herein by reference in its entirety, describe fluoropolymer formulations and coating metal objects with such formulations, wherein the coated object has “improved” scratch resistance and lubricious characteristics.

Teflon® PTFE is a nonstick two-coat (primer/topcoat) system. PTFE coatings have the highest operating temperature of any fluoropolymer (550° F.), an extremely low coefficient of friction, good abrasion resistance and good chemical resistance. Teflon® FEP is a low friction nonstick coating providing excellent chemical resistance. Teflon® PFA, having similar properties to FEP, offers the additional benefits of higher continuous use temperature (500° F.), film thicknesses up to 1,000 micrometers and greater toughness than PTFE or FEP. This combination of properties makes PFA an excellent choice for a wide variety of uses, especially those involving chemical resistance. Teflon® ETFE, also sold under the Tefzel® trademark, is the toughest of the fluoropolymers and can be applied at film builds up to 1,000 micrometers to provide a highly durable finish. Thus, fluoropolymer coatings such as PTFE, PFA, FEP and ETFE, set forth above, are particularly well suited as non-mar tire tool coatings of the invention.

In certain other embodiments, a fluoropolymer is a polyvinyl fluoride (PVF) or a polyvinylidene fluoride (PVDF) (see Example 3). PVF is frequently extruded into transparent film and often applied as a laminate protective layer onto outdoor surfaces. PVDF is often injection-molded, extruded or electrostatically applied. In one embodiment of the invention, a non-marring plastic is a PVDF or a modified PVDF such as PVDF2-Plus™ (Continental Industries, Inc.; Tualatin, Oreg.) described in Example 3. U.S. Pat. No. 4,557,977, incorporated herein by reference in its entirety, sets for a thermoplastic PVDF/acrylic blend used to coat steel and aluminum components, wherein the plastic coating exhibits excellent steel and aluminum adhesion.

### d. Vinyl Copolymers

Vinyl copolymers include most of the synthetic elastomers not described below under diene polymers (See Section 1.e), along with several specialty plastics and thermoplastic elastomers.

### i. Acrylonitrile-Butadiene-Styrene (ABS)

ABS is a graft copolymer made by dissolving styrene-butadiene copolymer in a mixture of acrylonitrile and styrene monomers, then polymerizing the monomers with free-radical initiators in an emulsion process. ABS is a tough, heat-resistant thermoplastic. The three structural units provide a balance of properties, the butadiene groups (predominantly trans-1,4) imparting good impact strength, the acrylonitrile affording heat resistance and the styrene units giving rigidity. ABS is widely used for appliance and telephone housings, luggage, sporting helmets, pipe fittings, and automotive parts. Thus, in certain embodiments of the invention, a non-marring plastic is an ABS or a blend thereof (e.g., ABS blended with SAN).

### ii. Styrene-Acrylonitrile (SAN)

Styrene and acrylonitrile, in a ratio of approximately seventy:thirty, are copolymerized under emulsion, bulk, or solution conditions using free-radical initiators. The copolymer is a rigid, transparent plastic that displays better resistance to heat and solvents than does polystyrene alone. Much of the SAN produced is blended with ABS. Principal uses are in automotive parts, battery cases, kitchenware, appliances, furniture, and medical supplies.

### iii. Styrene-Butadiene and Styrene-Isoprene Block Copolymers

These “tri-block” copolymers, also known as styrene-butadiene-styrene (SBS) and styrene-isoprene-styrene (SIS), consist of polystyrene sequences (or blocks) at each end of the chain and a butadiene or isoprene sequence in the center. Polystyrene end-blocks of adjacent chains collect together in small “domains,” so that clusters of polystyrene are distributed through a network of butadiene or isoprene. Such a structure makes SBS and SIS into thermoplastic elastomers, blends that exhibit the elasticity and resilience of polybutadiene or polyisoprene along with the permanence of the fixed ends. Like all thermoplastic elastomers, SBS and SIS are less resilient than permanently inter-linked molecular solids, and they do not recover as efficiently from deformation. Also, they soften and flow as the glass transition temperature of polystyrene (about 212° F.) is approached, and they are completely dissolved (and not merely softened) by suitable liquids. Nevertheless, SBS and SIS are easily processed and reprocessed, owing to the thermoplastic properties of polystyrene, and they are remarkably strong at room temperature. They are frequently used for injection-molded parts and as hot-melt adhesives (especially in shoes). In certain embodiments of the invention, a non-marring plastic is a SBS or a SIS.

### iv. Ethylene-Propylene Copolymers

There are two major types of ethylene-propylene copolymers with elastomeric properties: those made with the two monomers alone and those made with small amounts (approximately five percent) of a diene, usually ethylidene norbornene or 1,4-hexadiene. Both copolymers are prepared in solution, the former are known as EPM (ethylene-propylene monomer) and the latter as EPDM (ethylene-propylene-diene monomer). The copolymers contain approximately sixty percent by weight ethylene. A pronounced advantage of EPDM is that the residual carbon-carbon double bond (i.e., the double bond that remains after polymerization) is attached to the polymer chain rather than being made part of it. Carbon-carbon double bonds are quite reactive. For example, ozone in the atmosphere adds quickly to a double bond to form an unstable product that spontaneously decomposes. Regular diene polymers, such as natural rubber or styrene-butadiene rubber, have many double bonds in the main chain, so that, when one double bond is attacked, the entire molecule is broken. EPDM, with the double bonds located in the side groups, is much less susceptible to degradation by weathering and sunlight, because any breaking of the double bonds by ozonolysis, thermal deterioration, or oxidation leaves the main chains intact. In addition, some crystallinity appears to be induced by stretching, so that even without fillers, vulcanized ethylene-propylene copolymers are quite strong. However, like other hydrocarbon elastomers, the ethylene-propylene copolymers are swollen and weakened by hydrocarbon oils. The principal uses of EPM are in automobile parts and as an impact modifier for polypropylene. EPDM is employed in flexible seals for automobiles, wire and cable insulation, weather stripping, tire sidewalls, hoses, and roofing film.

EPDM is also mixed with polypropylene to make a thermoplastic elastomer. These polymer blends, which usually contain thirty to forty mole percent polypropylene, are rubbery solids, though they are not nearly as springy and elastic as covalently interlinked elastomers. However, owing to the thermoplastic properties of polypropylene, they can be processed and reprocessed, and they are resistant to oxidation, ozone attack, and weathering. They are therefore used in such low-severity applications as shoes, flexible covers, and sealing strips. The trademarked product Santoprene, produced by Advanced Elastomer Systems, L.P., is an example. Some block copolymers of ethylene and propylene, called polyallomers, are marketed. Unlike EPM and EPDM, which have a relatively amorphous morphology, the polyallomers are crystalline and exhibit properties of high-impact plastics.

### v. Plastisols

In certain embodiments, a non-marring plastic of the invention is a plastisol. Plastisols are made from one or more polyvinyl chloride (PVC), vinyl chloride-vinyl acetate copolymers, polyvinylidene chloride, vinylidene chloride copolymers, lower polyethylene oxides, etc. (e.g., see Example 7). U.S. Pat. No. 4,151,317, incorporated herein by reference in its entirety, describes plastisol compositions and methods thereof for coating metallic materials. Plastisols are commonly used to coat metal picnic benches, metal park benches, metal trash cans, barbecue grills, and the like. For example, QCM Industrial (Kent, Wash.) markets various plastisol formulations for dip coating metal. Depending on the formulation, a plastisol can be altered to produce a variety of different physical properties such as chemical resistance and abrasion resistance.

### vi. Polyacrylic/PVC Alloys

In another embodiment, a non-marring plastic of the invention is a polyacrylic/PVC alloy. In one embodiment, the polyacrylic/PVC alloy is Kydex® (Kleerdex Company; Aiken, S.C.). Kydex® is available as a resin for extrusion or injection molding or as 0.028 inch to 0.50 inch sheets suitable for thermoforming, laminating or machining. Kydex® compounds are available in various grades and most typically have a notched Izod impact resistance up to 18 foot pounds/inch (953 J/m). U.S. Pat. No. 5,992,957, incorporated herein by reference in its entirety, sets forth a method for eliminating abrasion/friction between sliding parts by thermoform coating the parts with Kydex®. In certain embodiments, a non-permanent sheath of the invention comprises Kydex®.

### e. Diene Polymers (Rubbers)

Dienes are compounds whose molecules contain two carbon-carbon double bonds separated by a single bond. The most important diene polymers are (polybutadiene, polychloroprene and polyisoprene) elastomers that are made into vulcanized rubber products.

### i. Polybutadiene (Butadiene Rubber)

Butadiene (CH₂═CH—CH═CH₂) is produced by the dehydrogenation of butene or butane or by the cracking of petroleum distillates. It is polymerized to polybutadiene by solution methods. Like the other diene polymers, polybutadiene is isomeric and can thus be produced with more than one molecular structure. A common elastomeric structure is cis-1,4 polybutadiene. Polybutadienes are made either with high cis content (95 to 97 percent) or with only 35 percent cis content along with 55 percent trans and 10 percent “side vinyl.” The properties of the two polymers are quite different. Although both display much higher resilience than other elastomers, the resilience of the mixed-isomer polymer is somewhat lower. In addition, the mixed polymer never crystallizes, so that, without reinforcing fillers such as carbon black, its products are weak and brittle. Much of the polybutadiene produced is blended with natural rubber (polyisoprene) or with styrene-butadiene rubber to give improved resilience and lower rolling resistance. More than half of all usage is in tires; other applications are footwear, wire and cable insulation, and conveyor belt. In certain embodiments, a non-marring plastic of the invention is a

### ii. Polychloroprene (Chloroprene Rubber)

Polychloroprene is the polymer name for the synthetic rubber known as neoprene. Neoprene is a good general-purpose rubber, but it is limited to special-properties applications because of its high cost. Of the several structures adopted by the chloroprene repeating unit, the most common is trans-1,4 polychloroprene. This polymer tends to crystallize and harden slowly at temperatures below about 50° F. It also crystallizes on stretching, so that cured components are strong even without fillers. Because the double bond between the carbon atoms is shielded by the pendant atoms and CH₂ groups, the molecular inter-linking necessary for producing a cured rubber is usually effected through the chlorine atom. The presence of chlorine in the molecular structure causes this elastomer to resist swelling by hydrocarbon oils, to have greater resistance to oxidation and ozone attack, and to possess a measure of flame resistance.

### iii. Polyisoprene

Of the several isomeric forms that polyisoprene can adopt, natural rubber consists almost exclusively of the cis-1,4 polymer. Natural rubber is extensible and tough, as evidenced by its ability to be stretched repeatedly to seven or eight times its original length. The polymer chains crystallize readily on stretching, lending greater strength, so that natural rubber is a self-reinforcing material. In its natural state, however, rubber is greatly affected by temperature: it crystallizes on cooling, taking only several hours to do so at −13° F. and it becomes tacky and inelastic above approximately 120° F. In addition, like other diene elastomers, it is swollen and weakened by hydrocarbon oils, and it reacts with oxygen and ozone in the atmosphere, leading to rupture of the polymer molecules and softening of the material over time. These disadvantages are overcome to a great extent by the vulcanizing and compounding processes.

### 2. Heterochain Polymers (Non-Vinyls)

A wide variety of heterochain polymers (i.e., polymers in which the backbone contains elements such as oxygen, nitrogen, sulfur, or silicon in addition to carbon) are contemplated for use as non-marring plastics of the invention. Representatives of each heterochain polymer family are described below.

### a. Aldehyde Condensation Polymers

Aldehyde condensation polymers are compounds produced by the reaction of formaldehyde with phenol, urea or melamine as set forth below.

### i. Phenol-Formaldehyde Polymers

Phenol-formaldehyde polymers, also known as phenolic resins, were the first completely synthetic polymers to be commercialized. Two methods are used to make phenol-formaldehyde polymers. In one, an excess of formaldehyde is reacted with phenol in the presence of a base catalyst in water solution to yield the resole, which is a low-molecular-weight pre-polymer with CH₂OH groups attached to the phenol rings. On heating, the resole condenses further, with loss of water and formaldehyde, to yield thermosetting network polymers. The other method involves reacting formaldehyde with an excess of phenol using an acid catalyst to produce pre-polymers called novolacs. Novolacs resemble the polymer except that they are of much lower molecular weight and are still thermoplastic. Curing to network polymer is accomplished by the addition of more formaldehyde or, more commonly, of compounds that decompose to formaldehyde on heating. Phenolic resins, invariably reinforced with fibers or flakes, are also molded into heat-resistant objects such as electrical connectors and appliance handles. In certain embodiments, a non-mar plastic of the invention comprises a phenol-formaldehyde polymer.

### ii. Urea-Formaldehyde Polymers

Resins made from urea-formaldehyde polymers are processed in much the same way as resoles (i.e., using excess formaldehyde). Urea-formaldehyde polymers are also used to treat textile fibers in order to improve wrinkle and shrink resistance, and they are blended with alkyd paints in order to improve the surface hardness of the coating. In certain embodiments, a non-mar plastic of the invention comprises a urea-formaldehyde polymer.

### iii. Melamine-Formaldehyde Polymers

Melamine formaldehyde polymers are similar to urea-formaldehyde resins in their processing and applications. In addition, their greater hardness and water resistance makes them suitable for decorative dinnerware and for fabrication into the tabletop and countertop product developed by the Formica Corporation and sold under the name Formica®. Melamine-based polymers are also extensively employed as cross-linking agents in baked surface-coating systems. As such, they have had many industrial applications, for instance, in automobile topcoats and in finishes for appliances and metal furniture. In certain embodiments, a non-mar plastic of the invention comprises a melamine-formaldehyde polymer.

### b. Polyamides

A polyamide is a polymer that contains repeating amide groups (R—CO—NH—R′) as integral parts of the main polymer chain. Synthetic polyamides are produced by a condensation reaction between monomers, in which the linkage of the molecules occurs through the formation of the amide groups. They may be produced by the interaction of a diamine (two amine (NH₂) groups) and a dicarboxylic acid (two carboxyl (CO—OH), or they may be formed by the self-condensation of an amino acid or an amino-acid derivative. The most important of the amide polymers are nylons and aramids (also known as aromatic nylons or aromatic polyamides).

Poly(meta-phenylene isophthalamide is an aromatic polyamide sold under the name Nomex® (DuPont®, Wilmington, Del.). The amide groups in Nomex® are separated by meta-phenylene groups, that is, the amide groups are attached to the phenyl ring at the 1 and 3 carbon positions. Nomex® and similar aramids are generally dry-spun from the solution in which the polymer is prepared. Poly(para-phenylene terephthalamide) is an aromatic polyamide sold under the trade name Kevlar® (DuPont®, Wilmington, Del.). Because of the rodlike structure of the para-oriented aramids, a “liquid-crystalline” solution is obtained that pre-orients the molecules even before they are spun, leading to as-spun fibers of ultrahigh strength and ultrahigh stiffness. Kevlar® polymers are wet-spun from a hot, high-solids solution of concentrated sulfuric acid.

Kevlar® has a unique and highly oriented structure which creates fibers with (1) extremely high tensile strength, six times stronger than steel on a pound for pound bases, (2) improved flexural strength and (3) excellent impact/chip resistance. Kevlar® and similar aramids are employed in belts for radial tires, cables, reinforced composites for aircraft panels and boat hulls, flame-resistant garments (especially in blends with Nomex®), sports equipment such as golf club shafts and lightweight bicycles, and as asbestos replacements in clutches and brakes.

Thus, in certain embodiments of the invention, a non-marring plastic comprises Kevlar®. In other embodiments of the invention, a non-marring plastic comprises Nomex®. In still other embodiments, a non-marring plastic comprises a blend of Kevlar® and Nomex®.

In certain embodiments, a non-marring plastic of the invention comprises a nylon (e.g., nylon 6, nylon 6,6, nylon 11, nylon 12). Nylon coatings are known for their highly durable and low frictional properties. U.S. Pat. No. 3,932,340, incorporated herein by reference in its entirety, describes a nylon coating having excellent abrasive resistance and adhesive strength to the object (substrate) coated. For example, the object to be coated (e.g., a tire tool) is dipped into a nylon containing solution (e.g., nylon 6, nylon 6,6, nylon 12) and then heated to remove the solvent, thereby forming the nylon coating film. U.S. Pat. No. 2,193,529, incorporated herein by reference in its entirety, describes nylon 6 and nylon 6,6 resins, and blends thereof. Example 2 of the invention describes a tire lever coated with nylon 12 via a fluidized bed.

### c. Polyesters

Polyesters are polymers made by a condensation reaction taking place between monomers in which the linkage between the molecules occurs through the formation of ester groups. The esters, which in almost all cases link an organic alcohol to a carboxylic acid, have the general structure R—COO—R′, where R and R′ are any organic combining groups. The major industrial polyesters include polyethylene terephthalate, polycarbonate, degradable polyesters, alkyds, and unsaturated polyesters.

In certain embodiments, a non-marring plastic of the invention comprises a polyester, a co-polymer thereof or a blend thereof. U.S. Pat. No. 4,304,883, incorporated herein by reference in its entirety, describes an unsaturated polyester resin used to coat metal surfaces, wherein the polyester resin comprises an unsaturated alkyd component and a polymerizable vinyl monomer. U.S. Pat. No. 5,470,912, incorporated herein by reference in its entirety, describes a polyester resin composition having enhanced flexibility and impact resistance. In certain embodiments, the polyester coating is applied to the tire lever via powder coating (e.g., see Example 10).

### i. Polyethylene Terephthalate (PET)

PET is produced by the step-growth polymerization of ethylene glycol and terephthalic acid. The presence of the large benzene rings in the repeating units gives the polymer notable stiffness and strength, especially when the polymer chains are aligned with one another in an orderly arrangement by drawing (i.e., stretching). In this semi-crystalline form, PET is made into a high-strength textile fiber marketed under such trademarked names as Dacron® (DuPont®, Wilmington, Del.). The stiffness of PET fibers makes them highly resistant to deformation, so that they impart excellent resistance to wrinkling in fabrics.

At a slightly higher molecular weight PET is made into a high-strength plastic that can be shaped by all the common methods employed with other thermoplastics. Recording tape and magnetic film is produced by extrusion of PET film (often sold as Mylar® and Melinex®). Molten PET can be blow-molded into a transparent container of high strength and rigidity that also possesses good impermeability to gas and liquid. In this form PET has become widely used in carbonated-beverage bottles and in jars for food processed at low temperatures. It is the most widely recycled plastic. Thus, in certain embodiments of the invention, a non-marring plastic comprises a PET. U.S. Pat. No. 6,046,264, incorporated herein by reference in its entirety, describes a general formulation for making thermoplastic PET suitable for injection molding.

### ii. Polybutylene Terephthalate (PBT)

PBT, a strong and highly crystalline engineering plastic, is similar in structure to PET but has a lower melting point, so that it can be processed at lower temperatures. It is used in applications similar to those of Mylar®. In one embodiment of the invention, a non-marring plastic comprises a PBT. U.S. Pat. No. 5,290,864, incorporated herein by reference in its entirety, describes thermoplastic PBT resin compositions and polymer blends thereof.

### iii. Polycarbonate (PC)

Polycarbonate (PC), marketed under the trademarked names Lexan® and Merlon®, is a special type of polyester used as an engineering plastic. It has exceptional stiffness, mainly by virtue of having more aromatic rings incorporated into the polyester chain. This structure is achieved by reacting bis-phenol A, an aromatic derivative of benzene, with phosgene, a highly reactive and toxic gas. Polycarbonate is highly transparent, has an impact strength considerably higher than most plastics, and can be injection-molded, blow-molded, and extruded. These properties lead to its fabrication into large carboys for water, shatter-proof windows, safety shields, and safety helmets. It is a favored plastic for injection-molding into compact discs (CDs). In certain embodiments of the invention, a non-marring plastic comprises PC. For example, U.S. Pat. No. 5,633,060, incorporated herein by reference in its entirety, describes PC resins for use as compact disc recording media, wherein the compact disc has excellent scratch resistance. U.S. Pat. No. 5,011,884, incorporated herein by reference in its entirety, sets forth ternary blends of the thermoplastics containing liquid-crystalline polyesters, polycarbonate and polyalkylene terephthalate, which are able to withstand considerable bending stresses without breaking. In certain embodiments, a non-mar plastic of the invention comprises a polycarbonate.

### iv. Alkyds and Oil-Free Coating Polyesters

Alkyds, or alkyd resins, are highly complex network polyesters (e.g., thermosets, cross-linked thermoplastics) that are manufactured for the paint industry. They are made from dicarboxylic acids or their anhydrides and polyfunctional alcohols such as glycerol. To the ester-forming monomers are added modifiers consisting of unsaturated oils such as tung oil, linseed oil, or dehydrated castor oil. The resulting polymers are thus branched polyesters with fatty-acid side groups. Because one of the first alcohols used to produce this type of polymer was glycerol (an alcohol derived from natural oils), the term alkyd has traditionally been used in organic coatings science to denote oil-based derivatives of polyester, while the term polyester is traditionally reserved for oil-free polyesters (described below).

When an alkyd-based coating is applied to a surface, the oil portion of the polyester undergoes a free-radical cross-linking reaction in the presence of oxygen from the surrounding air; this process, known as drying, yields a tack-free surface. A typical alkyd paint consists of the oil-modified polyester to form the coating film, a solvent such as hexane or mineral spirits to aid in application, metal naphthenates to catalyze the drying reaction, and pigment. A long-oil alkyd contains sixty percent fatty acid by weight, a medium-oil alkyd contains forty to sixty percent fatty acid, and a short-oil alkyd contains less than forty percent.

As is stated above, the term polyester, when used in the context of organic surface coatings, indicates a polyester free of natural-oil modifiers. Such polyesters are used extensively in coatings. The polymer can have a linear structure, but it is often branched, and it is usually in a relatively low-molecular-weight form that can be cross-linked to form a film of high performance. When the polyester is synthesized in the presence of an excess of alcohol, it tends to have hydroxyl end-groups on the molecules, and these molecules can be cross-linked through isocyanate, epoxy, and melamine compounds that react with the hydroxyl groups. If an excess of organic acid is present during polymerization, the polyester will have carboxyl end-groups, and these can become sites for cross-linking with epoxy, melamine, and amine groups. Polyesters with free-acid groups attached to their chains can be solubilized to a water-reducible form, as is the case with alkyds. In certain embodiments of the invention, a non-marring plastic comprises an alkyd polyester, a co-polymer thereof or blends thereof.

### v. Unsaturated Polyesters

Unsaturated polyesters are linear copolymers containing carbon-carbon double bonds that are capable of undergoing further polymerization in the presence of free-radical initiators. The co-polyesters are prepared from a dicarboxylic acid or its anhydride (usually phthalic anhydride) and an unsaturated dicarboxylic acid or anhydride, along with one or more dialcohols. Most commonly, maleic anhydride provides the unsaturated unit. The linear polymers are subsequently dissolved in a monomer such as styrene and are copolymerized with the styrene in a mold to form a network structure. Glass-fiber reinforcement is almost always used in products made of unsaturated polyesters. The principal applications are boat hulls, appliances, business machines, automobile parts, automobile body patching compounds, tubs and shower stalls, flooring, translucent paneling, storage tanks, corrosion-resistant ducting, and building components. In certain embodiments, a non-marring plastic of the invention comprises an unsaturated polyester.

### d. Polyethers

Polyethers are polymers that are formed by the joining of monomers through ether linkages (i.e., two carbon atoms connected to an oxygen atom). A variety of polyethers are manufactured, ranging from plastics to elastomers. The compounds also differ markedly in structure, though they all retain the ether (C—O—C) linkage.

### i. Polyacetal

Polyacetal, also called polyoxymethylene (POM) or simply acetal, has the simplest structure of all the polyethers. It is manufactured in a solution process by anionic or cationic chain-growth polymerization of formaldehyde (H₂C═O), a reaction analogous to vinyl polymerization. By itself, the polymer is unstable and reverts to monomer on heating to 250° F.; for this reason the commercial product is reacted further with acetic anhydride to cap the ends of the chains (where de-polymerization is initiated on heating) with acetate groups. Delrin® is an example of the end-capped polymer sold by DuPont® (Wilmington, Del.). It is a high-strength, highly crystalline plastic that exhibits a low coefficient of friction and excellent resistance to oils, greases, and solvents. Polyacetal and copolymers thereof have been used as a replacement for metal in plumbing and automotive parts. Principal uses include appliance parts, electronics components, gears, bushings, bearings, plumbing fixtures, appliances, toys, toiletry and cosmetic articles, food-processing equipment, zippers, and belt buckles. Thus, in certain embodiments of the invention, a non-marring plastic comprises a polyacetal.

### ii. Polyphenylene Oxide (PPO)

Polyphenylene oxide is prepared by oxidative coupling of phenylene oxide monomer using oxygen and a copper-based catalyst. The polymer is blended with polystyrene to produce a high-strength, moisture-resistant plastic marketed by General Electric Co. under the name of Noryl®. Polyphenylene oxide is used in telecommunications and computer equipment, automotive parts, appliances, pipes, and valves.

### iii. Polyetherketone and Polyetheretherketone

Polyetherketone (PEK) and Polyetheretherketone (PEEK) are high-strength, radiation-resistant plastics whose structures combine both ether and ketone groups. Both are thermally stable and highly resistant to chemicals. Principal uses are in machine parts, nuclear power-plant equipment, automobile parts, aerospace components, cable insulation, and pump parts. U.S. Pat. No. 6,566,484, incorporated herein by reference in its entirety, describes the formulation of a highly durable PEEK thermoplastic. In certain embodiments of the invention, a non-marring plastic comprises a PEK and/or a PEEK.

### iv. Epoxies

Epoxies are polyethers built up from monomers in which the ether group takes the form of a three-membered ring known as the epoxide ring. While many variations exist, the most common epoxy resin is formed from epichlorohydrin and bis-phenol A. These two monomers first form an epoxy pre-polymer that retains two terminal epoxide rings. In a typical epoxy reaction, the pre-polymers are further polymerized through the opening of the terminal epoxide rings by amines or anhydrides. This process, called curing, yields complex, thermosetting network polymers in which the repeating units are linked by linear ether groups. The highly polar network polymers characteristically exhibit excellent adhesive properties. In addition, because the curing reaction is easy to initiate and proceeds quite readily at room temperature, epoxy resins make very useful surface coatings. Most commonly a two-component system is used, in which one component is a low-molecular-weight polymer with amine end-groups and the other component is an epoxide-terminated polymer. The two components are mixed before application to the surface, where the polymer is allowed to cure (e.g., see Example 4).

In certain embodiments of the invention, a non-marring plastic is an epoxy. Epoxide compositions and methods for applying epoxide compositions are well known in the art (U.S. Pat. Nos. 6,045,873, 5,204,387 and 5,059,640, each incorporated herein by reference in its entirety). Typically, an epoxy resin is applied in either a liquid form or in a solid form used in powder coating.

### e. Polyimides

Polyimides are polymers that usually consist of aromatic rings coupled by imide linkages (i.e., linkages in which two carbonyl (CO) groups are attached to the same nitrogen (N) atom. There are two categories of these polymers, condensation and addition. Condensation polyimides are made by step-growth polymerization and are linear in structure. Addition polyimides are synthesized by heat-activated addition polymerization of diimides and have a network structure. Typical of the condensation type is the polyimide Kapton® (sold by DuPont®; Wilmington, Del.) which is made from a dianhydride and a diamine. When the two monomers react, the first product formed is a polyamide. The polyamide can be dissolved in solvents for casting into films, or it can be melted and molded. Conversion to polyimide occurs when the intermediate polyamide is heated above 300° F. Unlike the polyamide, the polyimide is insoluble and infusible. Kapton is stable in inert atmospheres at temperatures up to 930° F. Polyimides are amorphous plastics that characteristically exhibit great temperature stability and high strength, especially in the form of composites. They are used in aircraft components, sporting goods, electronics components, plastic films, and adhesives. In certain embodiments of the invention, a non-marring plastic comprises a polyimide.

### f. Polysiloxanes (Silicones)

Polysiloxanes are polymers whose backbones consist of alternating atoms of silicon and oxygen. Although organic substituents are attached to the silicon atoms, lack of carbon in the backbones of the chains makes polysiloxanes into unusual “inorganic” polymers. They exist as elastomers, greases, resins, liquids, and adhesives. Their great inertness, resistance to water and oxidation, and stability at high and low temperatures have led to a wide range of commercial applications.

The most common siloxane polymer, polydimethylsiloxane, is formed when the chlorine atoms of the monomer, dichlorodimethylsilane (Cl₂Si(CH₃)₂), are replaced by hyroxyl (OH) groups by hydrolysis. Siloxane molecules rotate freely around the Si—O bond, so that, even with vinyl, methyl, or phenyl groups attached to the silicon atoms, the molecule is highly flexible. Silicone rubbers are remarkably stable, and they have the lowest glass transition temperature and the highest permeability to gases of any elastomer. The Si—O bond is susceptible to hydrolysis and attack by acids and bases, and the rubber vulcanizates are relatively weak and readily swollen by hydrocarbon oils.

### g. Polysulfides

Polysulfides are polymers that contain one or more groups of sulfur atoms in their backbones. They fall into two types: compounds containing a single sulfur atom per repeating unit and compounds containing two or more sulfur atoms. Polyphenylene sulfide is a high-strength, highly crystalline plastic that exhibits good thermal stability and chemical resistance. It is polymerized by reacting dichlorobenzene monomers with sodium sulfide at about 480° F. in a high-boiling, polar solvent. Polymerization is accompanied by loss of sodium chloride. PPS is used principally in automotive and machine parts, appliances, electronic and electrical processing equipment, and coatings. In certain embodiments of the invention, a non-marring plastic comprises a polysulfide.

### h. Polyurethanes

Polyurethanes are a class of extremely versatile polymers that are made into flexible and rigid foams, fibers, elastomers, and surface coatings. They are formed by reacting an isocyanate (NCO) group with an alcohol (OH) group. Polyurethane molecules can adopt a linear or a network (e.g., cross-linked) architecture. Linear polyurethanes are formed by reacting a dialcohol with a diisocyanate, whereas network polyurethanes are formed from polyfunctional alcohols or isocyanates.

Polyurethanes form some of the highest-performance coatings available and a variety of polyurethane formulations are marketed. One type is a one-component (one-pot) pre-polymer containing excess isocyanate groups. Upon application of the liquid to a surface, these groups react with water from the atmosphere to form a urea, which further reacts with other isocyanate groups to provide the cross-linking necessary to cure the coating. In another one-pot formulation, the isocyanate groups of the pre-polymer are blocked by a phenol. Curing is accomplished by baking the coating to about 300° F. Alkyd-type one-pot coatings, in which the polyurethane is modified with drying oils, are also available. Polyurethanes are also made into two-component coatings, in which isocyanate-terminated pre-polymers serve as one component and a polyfunctional alcohol serves as the other. When the components are mixed in the presence of a catalyst, the isocyanate and alcohol groups react rapidly to cure the coating.

U.S. Pat. No. 6,100,361, incorporated herein by reference in its entirety, describes the formulation of polyurethane coatings for protecting the outer surface of golf balls against impact, the coating comprising a two-part solvent borne polyurethane system. The first part of the polyurethane system comprises a hydroxyl functional polyol having a hydroxyl equivalent such as a polyester, polyether or acrylic; or alternately, the hydroxyl functional polyol is a saturated polyether such as poly(oxydiethylene adipates) that are condensation products of diethylene glycol and adipic acid, branched with trimethylolpropane or pentaerythritol, and polycaprolactone(hydroxycaproic acid) polyesters. Polyols marketed by Miles Corporation (Pittsburgh, Pa.), under the name Desmophen™ are particularly contemplated for use herein (e.g., resins such as Desmophen 651A-65, Desmophen 670A-80 and Desmophen 631A-75). The second part of the polyurethane system comprises a blend of (1) an aliphatic diisocyanate (e.g., a dimer or a trimer of hexamethylene diisocyanate (HDI) as described in U.S. Pat. No. 5,549,220, incorporated herein by reference in its entirety) and (2) an aliphatic/aromatic polyisocyanate copolymer carried in a solvent. Dimers and trimers of HDI contemplated for use herein are sold by Miles Corporation (Pittsburgh, Pa.) under the trademark Desmodur™ (e.g., Desmodur N-3200 is a low viscosity dimer of HDI). Similarly, the aliphatic/aromatic polyisocyanate component contemplated for use are under the trademark Desmodur™ HL. Thus, in certain embodiments of the invention, a non-marring plastic comprises a polyurethane (e.g., see Example 5).

### i. Ionomer Resins

An ionomer is an ion containing co-polymer. An ionomer resins contains both non-ionic repeat units, and a small amount of ion containing repeat units. The ionic groups make up less than fifteen percent of the polymer. One example of an ionomer is poly(ethylene-co-methacrylic acid). Poly(ethylene-co-methacrylic acid) is a sodium or zinc salt (which provides the ions) comprised of co-polymers derived from ethylene and methacrylic acid.

In an ionomer, the nonpolar chains are grouped together and the polar ionic groups are attracted to each other. This allows thermoplastic ionomers to act in ways similar to that of crosslinked polymers or block copolymers. However, ionomers are not crosslinked polymers, and are in fact a type of thermoplastic called a reversible cross-linker. When heated, the ionic groups will lose their attractions for each other and the chains will move around freely. As the temperature increases, the chains move around faster and faster and the groups cannot stay in their clusters. This allows for a polymer with the properties of an elastomer and the processability of a thermoplastic. Ionomers are sometimes known as thermoplastic elastomers.

In one embodiment, a non-mar polymer of the invention is an ionomer resin (e.g., Surlyn® or Nucrel®). Surlyn® and Nucrel® (DuPont®, Wilmington, Del.) are a family of ionomers of ethylene methacrylic acid. U.S. Pat. No. 3,264,272, incorporated herein by referenced in its entirety, describes the process of forming ionic copolymers such as an ethylene/methacrylic acid copolymer (i.e., an ionomer). Ionomers such as Surlyn® have a proven history as being extremely impact resistant, which is a highly desirable property of a non-mar coating of the present invention. For example, U.S. Pat. No. 4,445,688, incorporated herein by reference in its entirety, describes the manufacture of bowling pins having a Surlyn® protective coating. Similarly, U.S. Pat. Nos. 5,567,772 and 6,544,131, each incorporated herein by reference in its entirety, describe a Surlyn® golf ball cover having improved durability (e.g., cut resistance) and resilience characteristics. U.S. Pat. No. 5,763,062, incorporated herein by reference in its entirety, describes a safety glass comprising a typical sheet of glass reinforced with a Nucrel® and Surlyn® mixture. Thus, in certain embodiments of the invention, a non-marring plastic comprises Surlyn®, Nucrel®, or a combination thereof.

The polymers (or polymer starting materials) set forth above, should not be construed as limiting the scope of the invention, as the Applicant contemplates that a non-marring tire tool may comprise any permanent or non-permanent plastic (i.e., a thermoplastic, a cross-linked thermoplastic, a thermoset or a thermoplastic elastomer) as long as the plastic serves as a “barrier” and protects the wheel rim from damage when contacted with a tire tool (i.e., the tire tool engages a tire bead).

### 3. Lubricious Agents

In certain embodiments, a non-mar tire tool further comprises a lubricious agent or coating thereof (e.g., see U.S. Pat. No. 6,127,320 and U.S. Pat. No. 3,937,676). As defined herein, the term “lubricious” is any composition which reduces friction. In one embodiment, a lubricious material is a fluorinated ether compound such as a fluorinated polyalkyl ether or a perfluorinated polyalkyl ether. Exemplary perfluorinated polyalkyl ethers are described in detail in U.S. Pat. No. 4,990,283 incorporated herein by reference. Commercially available compounds include those sold under the Fomblin® Y, Fomblin® Z or Galden® trademarks by Daikin America (Orangeburg, N.Y.). Additional references that describe these compounds and their methods of manufacture include U.S. Pat. No. 4,523,039, European Patent 148,482, U.S. Pat. No. 3,665,041 and International Application No. WO 87/00538. Kryton® brand perfluorinated polyalkyl ethers commercially available from DuPont®.

In certain embodiments, it is contemplated that one or more tire lubricating agents are applied to the tire and/or the plastic coated tire tool to further reduce friction (or increase lubricity). Tire lubricating agents are typically used to facilitate the sliding movement of the tire tool when inserted between the wheel rim and the tire bead. Non-limiting examples of tire lubricating agents include detergents, soaps, oils, silicons, water based jellies, mineral oils, graphite, rust inhibitors and the like.

### 4. Additives

In many plastics, the polymer(s) is/are the only constituent(s). However, in order to derive a set of properties appropriate to the final product, the polymer is often combined with other ingredients, or additives, which are mixed in during processing and fabrication. Among these additives are plasticizers, colorants, reinforcements, and stabilizers.

Plasticizers are used to change the T_{g} of a polymer. For example, polyvinyl chloride (PVC) is often mixed with nonvolatile liquids to change the T_{g}. Vinyl siding used on homes requires an unplasticized, rigid PVC with a T_{g} of 185° to 195° F. A PVC garden hose, on the other hand, should remain flexible even at 32° F. A mixture of thirty parts di(2-ethylhexyl)phthalate (also called dioctyl phthalate, or DOP) with seventy parts PVC will have a T_{g} of about 15° F., making it suitable for use as a garden hose.

Reinforcements are used to enhance the mechanical properties of a plastic. Finely divided silica, graphite, carbon black, talc, mica, and calcium carbonate, as well as short fibers of a variety of materials, can be incorporated as particulate fillers. Incorporating large amounts of particulate filler during the making of plastics such as polypropylene and polyethylene can increase their stiffness.

### C. PROCESSES FOR APPLYING THERMOPLASTICS, CROSS-LINKED THERMOPLASTICS AND THERMOSETS

A non-marring plastic of the invention (i.e., a permanent plastic polymer coating or a non-permanent plastic sheath) is applied to a tire tool by methods known to those of skill in the art. For example, in certain embodiments, a non-marring polymer is applied to the tire tool as a spray. In other embodiments, a non-marring polymer is applied to the tire tool by dipping the tire tool into a vessel containing the coating. In still other embodiments, a non-marring polymer is applied by painting the tire tool with the polymer. The following non-limiting examples describe various processes known in the art for applying plastic polymers coatings and/or forming plastic polymer sheaths.

Most often the plastic resins are supplied as cylindrical pellets (several millimeters in diameter and length) or as flakes and powders. Other forms include viscous liquids, solutions, and suspensions. Thermoplastics are changed into useful shapes by using many different processes. The processes that are used to mold or shape thermoplastics basically soften the plastic material so it can be injected into a mold, flowed through a die, formed in or over a mold, spayed (or brushed) directly onto a part, etc. The processes usually allow any scrap parts or material to be ground up and reused. Some of the more common processes are injection molding, extrusion, blow molding, rotational molding, calendering, forming, thermoforming (which includes vacuum forming), casting, brushing, spraying and dipping, fluidized bed coating, and the like.

Cross-linked thermoplastics and thermosets must use a process that allows the material to flow to the desired shape and then become crosslinked and rigid. The material cannot be remelted or reused after crosslinking occurs (e.g., epoxies). Some of the processes commonly used to process these materials are injection molding, transfer molding, compression molding, hand (or spray) lay-up, dipping, spraying, brushing, lamination, and filament winding.

### a. Injection Molding

“Injection Molding” is used to make three dimensional shapes with great detail. The thermoplastic plastic material is placed in a hopper of an injection molding machine where it is fed into a chamber to be melted. The melting is achieved by conducting heat into the material in a “plunger” machine, while the material is primarily heated by shearing or mechanically working the polymer in a “screw” machine. Several shots of plastic material are being heated and held in the injection unit. The maximum volume of material a machine can inject in a single shot determines its shot capacity. The capacity is given in ounces of a material.

Once melted the plastic is forced, under pressure, into the mold where it conforms to the shape of the cavity. The mold is temperature controlled, usually by circulating temperature controlled water through it. Once the part is cooled, the mold is opened and the part removed. The mold is then closed and ready for the next shot. The mold is clamped shut while the material is being injected in to the cavity since the cavity pressure may be as much as 5,000 psi. The clamp is sized by the “tonnage” it holds. Injection molding machines are referred to by their shot size in ounces and their tons of clamping ability.

The molds are most often made out of hardened steel and carefully finished. They are also made out of pre-hard steel, aluminum, epoxy, etc. The type of mold material selected depends on the number of parts to be made and the plastic material to be used.

The injection molding of a thermoset or cross-linked thermoplastic is similar to the injection molding of linear thermoplastics, except the material is kept cool until it is pushed into the heated mold where it is crosslinked. The mold is then opened and the hot, but rigid, part is removed.

### b. Extrusion

“Extrusion” is like squeezing toothpaste out of its tube. The process produces continuous two-dimensional shapes like sheet, pipe, film, tubing, gasketing, etc. The plastic material is fed into the extruder where it is melted and pumped out of the extrusion die. The die and the take-off line shape the plastic material as it cools and control the final dimensions of the cross-section of the shape. The equipment is designed and controlled to produce melted plastic at a very uniform temperature and pressure which control the size and quality of the extruded product.

### c. Extrusion Blow Molding

“Blow molding” or “extrusion blow molding” is process wherein a mold is manufactured in the shape of the tire tool and then a hot fluid polymer is blown into the mold with high pressure air. The polymer takes the shape of the tire tool and upon cooling results in a polymer sheath. For example, polymers such as polycarbonate (e.g., Lexan®), PVC, low density polyethylene (LDPE), high density polyethylene (HDPE) and polypropylene are blow molded to make products such as plastic milk bottles, windshield washer reservoirs, flotation buoys and the like.

### d. Forming and Thermoforming

The process of forming plastics into various shapes typically involves the steps of melting, shaping, and solidifying. As an example, polyethylene pellets are heated above their Tₘ, placed in a mold under pressure, and cooled to below their Tₘ in order to make the final product dimensionally stable. Thermoplastics in general are solidified by cooling below T_{g} or Tₘ. Thermosets and cross-lined thermoplastic are solidified by heating or chemical reaction in order to carry out the cross-linking reactions necessary for polymer network formation.

An extruded or cast thermoplastic sheet can be heated, draped over a mold, and allowed to cool to produce a permanent polymer coating or a non-permanent sheath (e.g., see Example 11). This process is called thermoforming. Two types of thermoforming are typically used, vacuum forming and pressure forming. In the vacuum forming process, cut-to-size polymer sheets are heated in ovens which use ceramic or gas heaters and zone controls to maintain an accurate measurement and control of the polymer sheet temperature. The sheet is then placed over a mold (e.g., a tire lever) and a vacuum is applied pulling the sheet into the shape of the mold. Vacuum forming is particularly advantageous for producing sheaths of the invention (e.g., a Kydex® sheath). Pressure forming is a process similar to vacuum forming, except with the addition of pressure which pushes the sheet into the shape of the mold (e.g., the tire lever). Pressure forming is often used for parts that require styling and aesthetic qualities because pressure forming creates greater detail allowing for textured surfaces, undercuts and sharp corners which are not as easily created with vacuum forming. Some examples of plastic parts made using thermoforming processes include signs, skylights, bubble packaging and boat/motorcycle windshields.

### e. Casting

Acrylic and nylons are often cast. As the name implies, the plastic material in a liquid form is poured into a mold and hardened. Tubing, rods, sheets, and slabs are often made via casting.

### f. Spraying, Brushing and Dipping

A thermoplastic polymer, after being heated to a liquid state, is sprayed or brushed onto a tire lever or the tire lever dipped into a polymer bath; and subsequently cooled back down to a solid state. A thermoset or a cross-linked thermoplastic polymer in the liquid form is also applied by spraying the tire lever with liquid a polymer, brushing the tire lever with a liquid polymer or dipping the tire lever into a liquid polymer and allowing the polymer to harden via cross-linking.

### g. Dry Powder Coatings

Dry powder coatings are plastic polymers that, upon application of heat, melt and flow out to a continuous and even film. Nylons, epoxies, vinyls, polyolefins, polyesters and polyethylenes are the polymers most frequently used for dry powder coating. The five basic methods used to apply plastic (dry powder) coatings are (a) fluidized bed coating, (b) electrostatic spray coating (often generically referred to as powder coating, (c) flame spray coating, (d) dip-to-line coating, and (e) flo-cad coating (also referred to as mini-coat).

### i. Fluidized Bed

“Fluidized bed” coating is a well known method consisting of a fluidized bed, which is typically a tank of dry powdered plastic that is aerated from below. The aeration causes the plastic particles to become suspended, making a fluid-like “bath” of turbulent particles. When a preheated metal tire lever is immersed in the tank, the plastic particles melt and adhere to its hot surface. When the tire lever is removed, all the particles on the surface fuse into a continuous coating (often referred to as flow out). If necessary, the tire lever is placed in an oven for additional curing.

### ii. Electrostatic Spray

“Electrostatic spray” coating is a process well known in the art (U.S. Pat. No. 6325,846, incorporated herein by reference in its entirety). For example, the tire lever is electrostatically charged, coated with an electrically chargeable dry powder plastic (e.g., a polyester resin) and the resin activated via heating (i.e., thermosetting) or the addition of a curing agent (e.g., see U.S. Pat. No. 6,303,706, incorporated herein by reference in its entirety).

### iii. Flame Spray

“Flame spray” coating utilizes a hand-held spray applicator, with the dry plastic powder being fed into a propane/compressed air-fueled flame, where it is melted and then blown against the surface of the tire lever at a high velocity. The plastic polymer immediately bonds with the tire lever, resulting in an extremely tough, tightly adhering coating.

### h. Transfer Molding

In transfer molding a thermoset or cross-linked thermoplastic, only enough polymer material for one shot is placed in a separate chamber or pot. The material is then pushed from the pot into the hot mold and crosslinked. All of the “cured” material is removed from the machine and another charge loaded for the next shot.

### i. Compression Molding

In compression molding a thermoset or a cross-linked thermoplastic, a single charge of the polymer material is placed directly into the cavity of the heated mold. The polymer flows and fills the cavity as the mold closes. The mold is kept closed until the polymer crosslinks. All of the cured material is removed from the mold prior to recharging the cavity. In one form of compression molding, a layer of reinforcing material is laid down before the polymer is introduced, thereby

### j. Spray Lay-Up

“Spray lay-up” is used to produce products, such as fiberglass boats and camper shells. The plastic resin (e.g., a polyester), is rolled or sprayed with glass reinforcement into a mold. A catalyst is added to the material to cause the material to crosslink or harden at room temperature. This process lends itself to making large and strong parts.

### k. Filament Winding

Filament winding is an automated version of the spray lay-up process. Reinforcing filaments are covered with a plastic resin and then wound over a mandrel. The number of layers and orientation are varied depending on the load that the part is to carry. A strong thin hollow part is left after the mandrel is removed. Storage tanks and street lighting poles are some examples of filament wound parts.

### D. NON-MARRING WHEEL WEIGHTS

In certain embodiments, the invention is directed to non-marring clip-on wheel weights also known as wheel balance weights. A wheel balance weight of the invention is of the clip-on type that is attached to a wheel rim at the rim flange, in contrast to adhesive type wheel weights. Clip-on style wheel weights, also known as steel spring clips are well known to one of skill in the automotive arts. A balance wheel weight for a vehicle wheel comprises a metal clip having a hook portion with a cross-sectional shape corresponding to a flange edge portion of the wheel and a leg portion for retaining a weight, which is capable of independently close-contacting and fixing to flange edge portion. A clip-on wheel weight is typically made from a lead alloy with a mass from ¼ to 14 ounces. The overall size of the wheel weight is directly proportional to its mass. One side of the wheel weight (i.e., the front) is marked with its mass and the other side (i.e., the back) comprises the clip (or hook) for attaching the wheel weight to the wheel rim. The clip is typically made of steel or aluminum and ranges in sizes from about ¼ inch to two inches.

A non-marring wheel weight of the invention comprises non-mar polymer coating set forth in Section B, wherein the entirety of the wheel weight comprises the polymer coating. It is imperative that the entirety of the wheel weight comprise the non-mar polymer, in contrast to a portion such as the clip or leg being coated. The polymer, covering the entirety of the wheel weight, ensures that the weight does not mar the wheel rim when attached to the rim. The polymer, covering the entirety of the wheel weight, also ensures that the weight does not mar the wheel rim in the event that the weight is not removed from the wheel rim before tire dismounting. In contrast to the non-marring tire lever set forth above, a non-marring wheel weight comprises a plastic or an elastomer. For example, in certain embodiments it is contemplated that an elastomeric polymer which coats the wheel weight clip (often referred to as a spring clip) improves the adhesion of the wheel weight to the rim flange.

Thus, in certain embodiments, the invention is directed to a non-marring, clip-on wheel weight, wherein the entirety of the wheel weight comprises one or more polymers (or polymer starting materials) selected from the group consisting of polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde, a vinyl acetate, a co-polymer thereof, a blend thereof and a combination thereof.

### E. EXAMPLES

The following examples are carried out using standard techniques, which are well known and routine to those of skill in the art, except where otherwise described in detail. The following examples are presented for illustrative purpose, and should not be construed in any way limiting the scope of this invention.

### Example 1

### Pre-Coating Preparation of Tire Levers

It is important, to ensure proper bonding of the polymer to the tire lever, that the metal surface of the tire lever is essentially free of contaminants such as oils, grease, oxidation and gases.

Thus, a tire lever of the invention is first cleaned by grit (or shot) blasting, abrasive wheel grinding or similar abrasive methods. Grit blasting serves to remove surface contaminants from the tire lever and provides a mechanical surface for the polymer coating to adhere. In order to ensure a clean surface, just prior to applying the polymer coating, the tire lever is degreased with a solvent such as denatured ethanol and/or an aqueous detergent and allowed to air dry. Alternatively, surface contaminants on the metal are removed by hot alkaline water rinse, sand blasting, vapor degreasing, acid etching with phosphoric acid, hydrofluoric acid, etc. Thus, the general rule of thumb is that the cleaner the tire lever surface, the better the polymer will bond to the surface. After cleaning the tire lever, avoid touching the surfaces and coat the tire lever as soon as possible.

Depending on the method of polymer application (e.g., injection molding, extrusion), certain metals, such as galvanized steel, may require degassing to yield a suitable polymer bond to the metal. Metal gassing usually occurs when air or water is trapped in the porous areas of the metal surface. Air gassing is caused when air is resident in the metal generally due to its porosity. For example, on heating the polymer coated tire lever in a cure oven, the air gas expands and releases through the polymer coating to form a small “volcano” or crater. Water gassing is caused by small quantities of water residing in the metal when it is porous. This type of gassing manifests itself by a large number of small “dots” in the polymer coating. If water gassing is excessive, the smaller bubbles will join up and form a larger blister where all adhesion will be lost. Methods for degassing metals are well known in the art. Typically, the metal tire lever is heated in an oven at a minimum temperature of 20° C. above the coating process temperature, for a time of at least as long as the heating period used in the coating process.

### Example 2

### Coating a Tire Lever with Nylon

A 20 cm long by 2 cm wide tire lever (part No. 08-0003; Motion Pro®, Inc.; San Carlos, Calif.) was cleaned by thoroughly sand blasting the entirety of tire lever. A thermoplastic nylon powder (Nylon 12, Continental Industries, Inc.; Tualatin, Oreg.) was then applied to the tire lever by fluidized bed coating. Nylon 12 (also referred to as polyamide 12) has a melting temperature of about 350° F., 300% elongation at break, a tensile strength of 3,626 psi and a Rockwell hardness value of R80. The tire lever was pre-heated to 500° F. and dipped into the fluid bed, with a flow out at 450° F. for ten minutes and then cooled to ambient temperature.

### Example 3

### Coating a Tire Lever with a Modified Polyvinylidene Fluoride (PVDF)

A tire lever (part No. 08-0003; Motion Pro®, Inc.) was cleaned by thoroughly sand blasting the entirety of tire lever. An electrostatic grade polyvinylidene fluoride (PVDF) powder (PVDF2-Plus™; Continental Industries, Inc.) was applied to the tire lever by the hot-flocking method. PVDF2-Plus™ is a copolymer of difluoroethylene and hexafluorpropylene with a Shore D hardness of 80, a 0.17 dynamic coefficient of friction and a melting temperature of 320° F. The tire lever was pre-heated to 500° F., hot flocked with PVDF2-Plus™, with a flow out at 500° F. for twenty minutes. This was repeated three times.

### Example 4

### Coating a Tire Lever with an Epoxy Thermoset

A 20 cm long by 2 cm wide tire lever (part No. 08-0003; Motion Pro®, Inc.; San Carlos, Calif.) was first cleaned by abrading with a 6×¾ inch crimped medium face wire wheel brush (part No. 00964129000; Sears, Roebuck and Co.) mounted to a 6 inch, 2.8 Amp bench grinder (part No. 00921106000; Sears, Roebuck and Co.), wherein the wire wheel brush was spinning at 3,450 rpm. Following the abrasion step, the tire lever was solvent wiped with denatured ethanol.

The epoxy used to coat the tire lever was purchased from Abatron, Inc. (Kenosha, Wis.). The Abatron epoxy is a two-part solvent based system comprising: (A) the epoxy resin (Abocoat 8508-1A; Abatron, Inc.) and (B) the epoxy hardener or curing agent (Abocure 8508-1B; Abatron, Inc.). The epoxy resin and the harder were mixed 1:1 by volume. Thus, 50 mL of the epoxy resin and 50 mL of the hardener were added to a one pint mixing can, stirred for five minutes and allowed to react for one hour at room temperature. The epoxy was then poured into a flat bottom paint mixing tray and the tire lever dipped into the epoxy for thirty seconds. The tire lever was then removed from the tray and cured at room temperature for one hour. A second coat of epoxy was applied by again dipping the tire lever into the epoxy for thirty seconds. Following this second dip, the epoxy coated tire lever was allowed to cure for twenty four hours. The epoxy coating, after two coats, had a 0.5 mm (0.023″) thickness.

### Example 5

### Coating a Tire Lever with a Polyurethane Thermoset

Two tire levers (part No. 08-0003; Motion Pro®, Inc.) were prepared as described in Example 4. A thermoset polyurethane coating was prepared as follows: (A) 200 mL of Abothane liquid polyurethane resin (Abothane 8901-4A; Abatron, Inc.; Kenosha, Wis.) was added to (B) 100 mL of Abocure liquid polyisocyanate curing resin (Abothane 8901-4B; Abatron, Inc.), and mixed by stirring for two minutes in a paint mixing tray. The overall viscosity was reduced by adding (C) 70 mL of the proprietary organic solvent Absolv (Absolv 8901-4; Abothane 8901-4B; Abatron, Inc.) to the polyurethane solution and mixed by stirring for five minutes. The final polyurethane formulation (i.e., 370 mL of A+B+C) was divided in half, wherein two paint mixing trays (tray one and tray two) contained about 185 mL of the final polyurethane formulation. To test the effects of a lubricious graphite filler, four grams of extra fine graphite (MicroFyne graphite, lot No. D547, 49 microns; Dixon Lubricants and Specialty Products; Asbury, N.J.) were added to mixing tray two and mixed by stirring for two minutes. The polyurethane in trays one and two was then allowed an initial curing set-up time of thirty minutes, after which time one tire lever was dipped into tray one for about thirty seconds and a second tire lever dipped into tray two for about thirty seconds. The tire levers were then removed from the trays and cured at room temperature for thirty minutes. A second coat of polyurethane was applied as described above and the polyurethane coated tire levers (±graphite) were allowed to cure for twenty four hours.

### Example 6

### Coating a Tire Lever with Protekote-92 (Teflon®)

In this example, a tire lever tool was coated with a Teflon® derived polymer sold under the trade name of Protekote-92 (Pro-Tek Coatings, Ltd.; Winnipeg, Manitoba Canada). The lever (Part No. 08-0003; Motion Pro®, Inc.) was cleaned by thoroughly sand blasting the entirety of lever and the Protekote-92 was applied to the lever by the fluidized bed coating as described previously.

### Example 7

### Coating a Tire Lever with a Plastisol

Conventional representative plastisols that are used in the present invention include polyvinyl chloride plastisols formed from homopolymers or copolymers of polyvinyl chloride (PVC) dispersed in a suitable plasticizer. PVC copolymers include, for example, copolymers of vinyl chloride with maleic anhydride, vinyl alcohol, vinyl acetate or (meth)acrylic acids, as described in U.S. Pat. No. 4,251,618, or copolymers of vinyl chloride monomers with copolymerizable comonomers such as acrylic esters derived from saturated C₂ to C₁₀ aliphatic alcohols, as described in U.S. Pat. No. 4,882,376. Additional plastisols contemplated for use in the present invention include the polyvinyl chloride-containing plastisols as, for example, those described in U.S. Pat. No. 4,388,363 and the copolymer resins containing (meth)acrylate compounds of vinyl ester as described in U.S. Pat. No. 4,613,639. The manner in which vinyl chloride polymers are formed is not critical to the practice of the present invention.

A representative and fairly typical formulation of a PVC containing plastisol composition would employ 100 parts of PVC resin, dispersion grade, and about 60 parts of dioctyl phthalate. Plasticizers that are useful in the preparation of plastisols include any compound that is of low volatility and which produce dispersions of the polymeric resin particles in the plasticizer and which upon the application of moderate heat, permeate the polymeric resin particles to cause adherence of such particles. Upon the application of additional heat, such plasticizers dissolve the resin causing fusion of the plasticizer and resin to yield a thermoset article. Typical plasticizers include normal and branched chain alcoholic esters and glycol esters of various mono-, di- and tribasic acids, for example, esters of phthalic, adipic, sebacic, azelaic, citric, trimellitic (and anhydride) and phosphoric acids; chlorohydrocarbons; esters of long chain alcohols; liquid polyesters; and epoxidized natural oils, such as linseed and soya oils. Representative phthalate plasticizers include: di-2-ethylhexyl (dioctyl) phthalate, diisoctyl phthalate, diisonyl phthalate, diisodecyl phthalate, n-C₆-C₈-C₁₀ phthalates, n-octyl-n-decyl phthalate, ditridecyl phthalate, butylbenzyl phthalate, dihexyl phthalate, butyl octyl phthalate, dicapryl phthalate, and di-2-ethylhexyl isophthalate. Additional plasticizers include: di-2-ethylhexyl adipate, diisonyladipate, n-octyl-n-decyl adipate, diisodecyl adipate, di-2-ethylhexyl azelate, tri-2-ethylhexyl trimellitate, triisonyl trimellitate, n-octyl-n-decyl trimellitate, tricresyl phosphate, cresyl diphenyl phosphate, 2-ethylhexyl diphenyl phosphate, decyl diphenyl phosphate, and polyester plasticizers.

Ideally the plasticizer exhibits good aging stability and crosslinkability upon curing. Plasticizers are typically employed in plastisol compositions within very broad ranges. Generally, the amount of polymer solids incorporated into the liquid plasticizer dispersing medium, taking into consideration characteristics such as coatability, wetting, ease of stirring, and the like, will be in the range of 5% to 95% by weight of the plastisol component of the present invention or in other words in an amount ranging from about 5 to about 2,000 parts of plasticizer per 100 parts per weight of polymeric resin.

Plastisol is typically heat cured or chemically cured via a cross-linking agent. In this example, the plastisol is heat cured onto the tire lever. Thus, a well controlled industrial oven is used to effectively coat the tire lever with plastisol. The tire lever is prepared (or cleaned) by solvent wipe, vapor degreasing or sandblasting. A primer is optionally applied to the tire lever for maximum plastisol adhesion. The coating thickness of the plastisol can vary from 0.01 inch (fast, single dip with 350° F. part) to 0.125 inch (slow dip, possibly double dip with extra hot parts 375-400° F.). Thus, plastisol coating thickness on the finished tire lever will be directly related to (1) the gel temperature of the plastisol, (2) the temperature of the tire lever when it is dipped into the plastisol (i.e., variations in the length of time between removal of the part from the oven and dipping in the plastisol will result in variations in ultimate coating thickness), (3) the mass of the hot part of the tire lever (i.e., small parts will quickly cool to below the gel temperature of the plastisol resulting in low film thickness, while larger parts will hold heat longer and gel on a greater amount of plastisol) and (4) the rate of heat transfer of the particular tire lever metal composition (i.e., its conductivity). The heated tire lever is dipped in a pail or tank of plastisol and immediately removed, whereupon the plastisol is cured (i.e., hardened) in a 350-400° F. oven for about 3 to 4 minutes.

### Example 8

### Coating a Tire Lever with Teflon® PTFE

In this example, the polytetrafluoroethylene (PTFE) fluoropolymers are provided as 60% dispersions in water (see Table 1). The compositions are blended by techniques normal in the art and then applied to a smooth, degreased tire lever by spraying. A low melt viscosity PTFE coating system has a typical composition as shown in Table 4.

TABLE 4

| Weight Percent | |
|---|---|
| 0.008 | Zinc oxide |
| 0.050 | “Afflair 153” titania coated mica from EM Industries |
| 6.701 | Ultramarine blue pigment |
| 6.966 | “T-30” PTFE from Du Pont |
| 1.002 | “Ludox AM” colloidal silica from Du Pont |
| 4.760 | L171 PTFE micropowder from ICI |
| 4.790 | Al-10 polyamide imide resin from Amoco |
| 66.319 | Deionized water |
| 0.455 | “Triton X-100” octyl phenol polyether alcohol non-ionic |
| | surfactant from Rohm and Haas |
| 0.676 | Diethylethanolamine |
| 1.352 | Triethylamine |
| 3.728 | Furfuryl alcohol |
| 3.193 | N-methyl pyrolidone |
| 100.000 | TOTAL |

The PTFE coating is applied at 5-10 μm dry film thickness (DFT) to a tire lever which has been washed to remove oil and dirt contamination and air dried. A second and third PTFE coating are applied at 15-17 μm DFT as needed. The films are baked 10 minutes at 150° C. followed by a high temperature bake for a minimum of 3 minutes over 415° C.

### Example 9

### Coating a Tire Lever with PlastiDip®

PlastiDip® is a commercially available elastomer rubber (Plasti Dip® International; Blaine, Minn.) sold in most hardware and home improvement stores. The PlastiDip® material includes rubbers such as styrene-ethylene/butylene-styrene (SEBS) and styrene-ethylene/propylene-styrene (SEPS), along with solvents, plasticizers, etc., including 1,1,1-trichloroethane, VM&P naphtha, toluene, heptane and materials such as antioxidants.

A 20 cm long by 2 cm wide Motion Pro® tire lever was abraded and cleaned as descried in Example 4. One end of the tire lever (i.e., about 10 cm) was dipped is directly into a 429 mL can of yellow PlastiDip and cured at ambient temperature for twenty-four hours.

### Example 10

### Electrostatic Spray Coating a Tire Lever

Powder coating resins for coating metal are well known in the art (e.g., see U.S. Pat. Nos. 6,491,973, 6,472,472 and 6,239,215). In this example, the tire lever is powder coated with a 50 parts epoxy, 50 parts polyester resin blend. A clean tire lever is electrically grounded and sprayed with electrostatically charged 50/50 epoxy/polyester resin. The tire lever is then placed in an oven, where it bakes at 400° F. for about ten minutes, wherein the resin melts and flows into a durable non-mar coating.

### Example 11

### A Non-Permanent Non-Mar Kydex® Sheath

Kydex®, a thermoplastic copolymer of acrylic/PVC, is available is various grades and is supplied as either an acrylic/PVC resin or a thermoplastic sheet. Kydex® 100 is an extremely durable thermoplastic sheet which is easily thermoformed, yet is breakage and chemical resistant. For example, some of the physical properties of Kydex® 100 are a tensile strength of 42 N/mm², a 160% elongation at break, a flexural strength of 64 N/mm², an elasticity modulus of 2319 N/mm², a Rockwell hardness (R) of 94, a notched Izod impact resistance of 953 J/m at 23° C. and a 0.038% weight loss after a 1000 cycle Taber abrasion resistance test. Thus, Kydex® 100 is a particularly preferred polymer for both permanent tire lever coatings and non-permanent tire lever sheaths.

In this example, a 0.25 inch thick sheet of Kydex® 100 was used to form a non-permanent tire lever sheath. A 20 cm long by 2 cm wide tire lever (part No. 08-0003; Motion Pro®, Inc.; San Carlos, Calif.) was solvent wiped twice with denatured ethanol. The Kydex sheet was cut into a 11 cm by 4.5 cm strip. Kydex® 100 is thermoformed at a temperature range of 163° C. to 200° C. (325-392° F.) and can thus be thermoformed by a heat gun or a conventional oven. In this example, the tire lever was placed in a conventional Black & Decker® electric toaster oven (Applica Consumer Products, Inc.; Miami Lakes, Fla.) and heated to 350° F. After the oven reached 350° F., the 11 cm pre-cut Kydex® strip was placed in the oven lengthwise over one half of the 20 cm tire lever, with a 1 cm overlap at lever. The Kydex® became visibly pliable after five minutes in the oven, at which time the tire lever/Kydex® were removed from the oven using oven mitts. The thermoforming or working time of the pliable Kydex® after heating to 350° F. was about 30 seconds. Thus, the pliable Kydex® was quickly (i.e., in about ten seconds) shaped into a sheath around the tire lever and compressed by hand for one minute. Upon release of the manual compression, the sheath retained its shape, was cool to the touch and was easily removed from the tire lever.

### Example 12

### A Non-Permanent Non-Mar Surlyn® Sheath

Ionomer resins such as Surlyn®, manufactured by E.I. DuPont de Nemours, comprise ionically cross-linked ethylene-methacrylic acid and ethylene-acrylic acid copolymers. Properties which distinguish these ionomer resins from other polyolefin heat-seal polymers are high clarity, tear resistance, abrasion resistance, solid-state toughness and resistance to oil-fat permeation.

Ionic copolymers such as Surlyn® comprise a polymer of an a-olefin having the general formula RCH═CH₂, where R is a radical selected from the class consisting of hydrogen and alkyl radicals having 1 to 8 carbon atoms, the olefin content of the polymer being at least 50 mol percent based on the polymer, and an α,β-ethylenically unsaturated carboxylic acid having 1 or 2 carboxylic acid groups, the acid monomer content of the polymer being from 0.2 to 25 mol percent based on the polymer. The carboxylic acid-containing polymer contains uniformly distributed throughout the polymer one or more metal ions having ionized valences of 1 to 3 inclusive where the acid comonomer is monocarboxylic, and an ionized valence of one where the acid monomer is dicarboxylic, the quantity of the metal ion being sufficient to neutralize at least 10 percent of the carboxylic acid. For a complete description of ionomer formulation, cross-linking and the like, see U.S. Pat. No. 3,264,272, incorporated herein by referenced in its entirety.

Various grades of ionomer resins are available for extrusion coating, film coating and the like. Table 5 is representative of a typical ionomer grades and their formulation.

TABLE 5
IONOMER FORMULATIONS

| | Parts by Weight | | |
|---|---|---|---|
| Formulation | I | II | III |
| Hi-milan 1605^{a} | 5 | — | — |
| Hi-milan 1555^{b} | 10 | — | — |
| Hi-milan 1855^{c} | 85 | — | — |
| Surlyn AD8512^{d} | — | 25 | 30 |
| Surlyn AD8511^{e} | — | 25 | 30 |
| Epofriend A1010^{f} | — | 15 | 40 |
| Septon HG-252^{g} | — | 35 | — |
| Titanium dioxide | 2.0 | 2.0 | 2.0 |
| Barium sulfate | 2.0 | 2.0 | 2.0 |

^{a}Hi-milan ™ 1605 (trade name), ethylene-methacrylic acid copolymer ionomer resin.
^{b}Hi-milan ™ 1555 (trade name), ethylene-methacrylic acid copolymer ionomer resin.
^{c}Hi-milan ™ 1855 (trade name), ethylene-methacrylic acid-isobutyl acrylate terpolymer ionomer resin.
^{d}Surlyn ® AD8512 (trade name), ethylene-methacrylic acid copolymer ionomer resin.
^{e}Surlyn ® AD8511 (trade name), ethylene-methacrylic acid copolymer ionomer resin.
^{f}Epofriend ™ AT1010 (trade name), styrene-butadiene-styrene block copolymer with epoxy groups. Styrene/butadiene (weight ratio) = 40/60, content of epoxy = 1.5 to 1.7% by weight.
^{g}Septon ™ HG-252 (trade name), hydrogenated styrene-isoprene-styrene block copolymer having terminal - OH group.

A sufficient quantity of ionomer resin pellets (e.g., Surlyn® 1707) are injection molded to provide matching pre-forms approximately corresponding to the exterior configuration of one half of the tire lever lengthwise. A tire lever, coated with a suitable release agent, is placed sandwich fashion between a pair of Surlyn® resin pre-forms. The pre-forms are compression molded about the tire lever under a force of 10 to 45 tons and at a temperature of 300° F. to 350° F. The resin-enclosed tire lever is cooled to about 120° F., taken from the compression mold and the Surlyn® resin sheath is removed from the tire lever. This example should not be construed as limiting in any way, as it merely provides guidance for one of skill in the art. Variations of this method and alternative methods are contemplated for preparing both permanent and non-permanent coatings and are readily apparent to one of skill in the art.

### Example 13

### Increasing the Lubricity of a Non-Mar Coating

To reduce friction and/or abrasion of a coated tire lever of the invention, a lubricious coating is applied to the tire lever. Thus, a tire lever having been coated with one or more of the polymers set forth above, is further coated with a lubricious coating known in the art. For example, 98% (by weight) perfluorinated polyalkyl ether is blended with 2% thixotropic clay, and coated onto the surface of a tire lever having a non-mar polymer coating. The coating is applied via a glass rod, dip or brush. As applied, the lubricious composition is in a gel or paste-like state. The coating is cured at room temperature for about 24 hours. Alternatively, a lubricious compound or agent is blended with or added to a polymer

### Example 14

### Testing the Non-Marring Properties of Various Polymers

Polymer Scratch (Mar) Test

In this example, the protective effect of a polymer coated tire lever contacting (rubbing against) a wheel rim was simulated as follows: A piece of 12 inch×18 inch stainless steel sheet metal (twenty six gauge) was polished to a mirror like finish using an automotive steel and aluminum wheel polish. The metal sheet was then wiped clean with denatured ethanol to remove any trace of the wheel polish. The metal sheet was then evenly divided into a grid of twenty-four squares (3 inch×3 inch squares) by marking the sheet with a Sharpie® pen. Table 6 below shows the grid divided into twenty-four squares, the polymer which was rubbed in each square and the qualitative polymer performance score of zero, one, two or three, with one being the worst score and three the best.

The test consisted of rubbing a polymer (or a positive control) in its assigned grid space listed Table 6. Each polymer was rubbed diagonally in a back and forth motion, starting in the bottom left grid corner and ending at the upper right grid corner, for a total of twenty rubs. Grid number seven was a control grid in which nothing was rubbed, and thus served as a visual calibration for non-marring. Grid numbers fifteen and sixteen were control grids in which a tungsten carbide cutter and a bare steel (non-coated) tire lever were rubbed, respectively, and thus served as positive controls for scratch/marring.

The scoring system is as follows: (a) a score of zero was assigned to any polymer which scratched its grid, wherein a scratch is visible as a diagonal indentation or scratch in metal surface. A score of one was assigned to any polymer that did not scratch its grid, but had low lubricity (or high friction). A score of two was assigned to any polymer that did not scratch its grid, had high lubricity (or low friction), but left a trace amount of polymer residue on the metal surface. It should be noted that the polymer residue observed for score two polymers was readily wiped from the metal surface with either denatured ethanol or mild detergent. A score of three was assigned to any polymer that did not scratch its grid, had high lubricity (or low friction) and did not leave a polymer residue on the metal surface.

TABLE 6
POLYMER SCRATCH TEST

| | | | | | |
|---|---|---|---|---|---|
| 1 | 2 | 3 | 4 | 5 | 6 |
| Plasti-Dip ® 1 | Epoxy 2 | PVDF 2 | PVC 3 | Tivar 1000 3 | Tivar DrySlide 2 |
| 7 | 8 | 9 | 10 | 11 | 12 |
| (−) Control 3 | Nylon 12 3 | Polycarbonate 3 | Lucite 3 | LPDE 2 | |
| 13 | 14 | 15 | 16 | 17 | 18 |
| Neoprene 1 | Teflon Sheet 3 | (+) Control | (+) Control | PP clear 3 | PP white 2 |
| | | Carbide cutter 0 | Steel Tire Lever 0 | | |
| 19 | 20 | 21 | 22 | 23 | 24 |
| Polyurethane + 3 | Polyurethane 3 | Protekote 92 2 | Kydex sheath 2 | Sanalite 3 | HDPE 2 |

The scratch test was designed to measure (qualitatively) the ability of the steel sheet to withstand the friction applied by rubbing various polymers The following is a brief description of each polymer tested:

1. The Plasti-Dip® sample used in grid 1 (score 1) was the coated tire lever described in Example 9. The Plasti-Dip® did not mar the metal sheet, but tended to grab and hold the metal surface during the scratch test. This lack of lubricity would not function well during the tire mounting and dismounting process, which requires the tire lever to move freely around the circumference of the wheel rim. In addition, due to elastic nature of the Plasti-Dip®, the coating will tend to tear or rip away from the tire lever (e.g., see Abrasive Wheel Test below).

2. The epoxy sample used in grid 2 (score 2) was the coated tire lever described in Example 4.

3. The polyvinylidene fluoride (PVDF) sample used in grid 3 (score 2) was the coated tire lever described in Example 3.

4. The polyvinyl chloride (PVC) sample used in grid 4 (score 3) was a grade 1, type 1 PVC, which was obtained as a small rectangular block (2 inch width×4 inch length×⅛ inch thickness) from Interstate Plastics (Sacramento, Calif.).

5. The Tivar®1000 sample used in grid 5 (score 3) was an ultra high molecular weight polyethylene (UHMWPE), which was obtained as a small rectangular block from Interstate Plastics.

6. The Tivar® DrySlide sample used in grid 6 (score 2) was a modified ultra high molecular weight polyethylene (UHMWPE), which was obtained as a small rectangular block from Interstate Plastics.

7. The Nylon 12 sample used in grid 8 (score 3) was the coated tire lever described in Example 2.

8. The polycarbonate sample used in grid 9 (score 3) was a 4×4 inch square sheet (1/32 inch thickness) obtained from Interstate Plastics.

9. The Lucite sample used in grid 10 (score 3) was a 4 inch×4 inch square sheet (1/32 inch thickness) obtained from Interstate Plastics.

10. The low density polyethylene (LDPE) sample used in grid 11 (score 2) was obtained as a small rectangular block from Interstate Plastics.

11. The neoprene rubber sample used in grid 13 (score 1) was a neoprene O-ring obtained at a local automotive store. The neoprene rubber did not mar the metal sheet, but tended to grab and hold the metal surface during the scratch test. This lack of lubricity would not function well during the tire mounting and dismounting process, which requires the tire lever to move freely around the circumference of the wheel rim; and would further be prone to tear or rip away from the tire lever.

12. The Teflon® sheet used in grid 14 (score 3) was a 4×4 inch square sheet (1/32 inch thickness) obtained from Interstate Plastics.

13. The tungsten carbide cutter used as a positive control in grid 15 (score 0) was obtained local hardware store (Dremel® Part No. 9933).

14. The non-coated tire lever used a positive control in grid 16 (score 0) was a Motion Pro® lever (part No. 08-0003).

15. The polypropylene (PP) sample used in grid 17 (score 3) was a clear polypropylene homopolymer, which was obtained as a small rectangular block from Interstate Plastics.

16. The polypropylene (PP) sample used in grid 18 (score 2) was a white pigmented polypropylene homopolymer, which was obtained as a small rectangular block from Interstate Plastics.

17. The polyurethane sample used in grid 19 (score 3) was the polyurethane plus graphite coated tire lever described in Example 5.

18. The polyurethane sample used in grid 20 (score 3) was the polyurethane coated tire lever described in Example 5.

19. The Protekote-92 sample used in grid 2 (score 2) was the Protekote-92 tire lever described in Example 6.

20. The Kydex® sheath sample used in grid 22 (score 2) was the Kydex® tire lever sheath described in Example 11.

21. The Sanalite® used in grid 23 (score 3) was obtained as a small rectangular block from Interstate Plastics.

22. The high density polyethylene (HDPE) used in grid 24 (score 3) was obtained as a small rectangular block from Interstate Plastics.

Polymer Abrasive Wheel Test

This test was designed to establish the long-term durability of a tire lever coated (or sheathed) with a plastic polymer of the invention versus an elastomeric (rubber) polymer. The polymers tested in this example were (a) the nylon coated tire lever from Example 2, (b) the PVDF coated tire lever from Example 3, (c) the epoxy coated tire lever from Example 4, (d) the polyurethane coated tire lever from Example 5, (e) the Protekote-92 coated tire lever from Example 6, (f) the Plasti-Dip® coated tire lever from Example 9 and (g) the Kydex sheathed tire lever from Example 11.

The general concept is that the abrasive wheel simulates the long-term effects of repeated tire lever use. The abrasive wheel was 6×¾ inch crimped coarse face wire wheel brush (part No. 00964129000; Sears, Roebuck and Co.) mounted to a 6 inch, 2.8 Amp bench grinder (part No. 00921106000; Sears, Roebuck and Co.), wherein the wire wheel brush was spinning at 3,450 rpm. Each of the tire levers above (i.e., tire levers coated with polymers a-g) was placed against the wire wheel with firm and equal pressure for five minutes. The levers were weighed before and after the abrasive wheel test.

To ensure that equal pressure was applied to each test lever, a pressure spring device was built as follows: a sheet metal blocking plate (2 inch×2 inch square; 26 gauge) was welded at one end of a 1 inch long hollow steel tube (1.5 inch diameter), to “close off” one end of the hollow tube. The welded sheet metal was perpendicular to the hollow axis of the steel tube. A two inch steel spring (one inch in diameter) was inserted into open end of the hollow steel tube, such that the spring protruded about one inch from the open end of the hollow tube and was abutted against the sheet metal blocking plate at the other end. The pressure spring device was then held in the right hand and pressed against the tire lever (held with the left hand) with just enough hand pressure to compress the spring into the steel tube.

After subjecting each tire lever to the abrasive wheel test, the levers were analyzed. The average polymer thickness of the coated levers was about 0.023 inches (0.6 mm), such that the scale used to weigh the levers was not sensitive enough to detect a weight change with any of the levers. A qualitative inspection of the levers did however indicate that each of the plastic polymers (i.e., polymers a-e and polymer g) were extremely durable and did not tear away from the tire levers. In contrast, the rubber polymer (i.e., polymer f tore away from the tire lever within the first minute of the abrasion wheel test, exposing the metal surface of the tire lever.

Hammer Impact Test

The hammer impact test was designed to asses the impact resistance of the polymers after their were applied to the tire levers. The polymers tested in this example were (a) the nylon coated tire lever from Example 2, (b) the PVDF coated tire lever from Example 3, (c) the epoxy coated tire lever from Example 4, (d) the polyurethane coated tire lever from Example 5, (e) the Protekote 92 coated tire lever from Example 6, (f) the Plasti-Dip® coated tire lever from Example 9 and (g) the Kydex sheathed tire lever from Example 11.

Each polymer coated lever was struck ten times (using overlapping blows) with the flat face of a 32 ounce ball pein hammer (part No. 00938467000; Sears, Roebuck and Co.). The nylon polymer (a), the PVDF polymer (b), the polyurethane polymer (d), the Protekote-92 polymer (e) and the Kydex sheath polymer (g) were each highly impact resistant and exhibited no signs of chipping or loss of adhesion to the lever. The epoxy polymer (c) exhibited slight chipping after the eighth hammer blow and a small surface of the metal lever (approximately 0.2 cm in diameter) was exposed. The Plasti-Dip® polymer (f began tearing and lifting away from the tire lever after the second hammer blow; and large surface of the metal lever was exposed after the tenth blow, approximately equal to the diameter of the hammer face (i.e., 3 cm).

Additional Abrasion Resistance Test Methods

Additionally, a number of quantitative abrasion resistance test methods may be employed, including but not limited to the Taber Test (ASTM D-4060), the Tumble Test and Standard Method for the Modified Bayer Test (ASTM F735-81). There are also qualitative test methods that may be used for measuring abrasion resistance, including the Steel Wool Test and the Eraser Test. In the Steel Wool Test and the Eraser Test, coated tool samples are scratched under reproducible conditions (constant load, frequency, etc.). The scratched test samples are then compared and rated against standard samples. A semi-quantitative application of these test methods involves the use of an instrument, such as a Spectrophotometer or a Colorimeter, for measuring the scratches on the coated substrate as a haze gain.

What is claimed is:

1. A tire changing tool comprising (a) a lever, wherein the lever has a first lever end portion, a second lever end portion and a lever body connecting the first and second end portions and (b) a polymer coating, wherein the polymer coating covers at least one lever end portion.

2. The tire tool of claim 1, wherein the polymer coating is further defined as permanently bound to the entire surface area of at least one lever end portion the tire tool.

3. The tire tool of claim 1, wherein the polymer is a plastic polymer.

4. The tire tool of claim 3, wherein the plastic polymer is further defined as a thermoplastic, a cross-linked thermoplastic, a thermoset or a thermoplastic elastomer.

5. The tire tool of claim 4, wherein the plastic polymer comprises one or more polymers selected from the group consisting of a polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde and a vinyl acetate.

6. The tire tool of claim 2, wherein the entire surface area of the first lever end comprises a polymer coating and the entire surface area of the second lever end comprise a polymer coating.

7. The tire tool of claim 6, wherein the first lever end and the second lever end comprise a different polymer coating.

8. The tire tool of claim 2, wherein the entire surface area of the lever comprises the polymer coating.

9. The tire tool of claim 1, wherein the lever is comprised of one or more materials selected from the group consisting of steel, stainless steel, hardened alloy steel, chrome plated steel, forged steel, chrome-vanadium steel, aluminum, magnesium, titanium, Kevlar® and carbon fiber.

10. The tire tool of claim 5, wherein the ionomer resin is an ethylene/methacrylic acid.

11. The tire tool of claim 5, wherein the polyamide is a nylon.

12. The tire tool of claim 11, wherein the nylon is a nylon 6, a nylon 6,6, a nylon 6,9, a nylon 6,11, a nylon 6,12, a nylon 11 or a nylon 12.

13. The tire tool of claim 5, wherein the polyvinyl is a polyvinyl chloride (PVC)/polyacrylic alloy.

14. The tire tool of claim 5, wherein the polyvinylidene is a polyvinylidene fluoride (PVDF).

15. The tire tool of claim 5, wherein the fluoropolymer is a polytetrafluoroethylene (PTFE), a perfluoroalkoxy (PFA), a fluorinated ethylene propylene (FEP) or an ethylene tetrafluoroethylene (ETFE).

16. The tire tool of claim 1, further comprising one or more additional lever end portions connected to the lever body.

17. The tire tool of claim 1, further comprising a non-permanent polymer sheath.

18. The tire tool of claim 17, wherein the polymer sheath comprises one or more polymers selected from the group consisting of a polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde and a vinyl acetate.

19. The tire tool of claim 17, wherein the sheath covers the entire surface area of at least one lever end of the tire tool, wherein the lever end is defined as a lever end portion which engages a wheel rim.

20. The tire tool of claim 18, wherein the ionomer resin is an ethylene methacrylic acid.

21. The tire tool of claim 18, wherein the polyvinyl is a PVC/polyacrylic alloy.

22. The tire tool of claim 18, wherein the polyamide is nylon.

23. The tire tool of claim 18, wherein the polyvinylidene is a PVDF.

24. The tire tool of claim 18, wherein the fluoropolymer is PTFE, PFA, FEP or ETFE.

25. A kit comprising (a) a tire changing tool, the tool comprising a lever having a first lever end portion comprising a permanent polymer coating, a second lever end portion comprising a permanent polymer coating and a lever body connecting the first and second end portion and (b) at least one polymer sheath.

26. The kit of claim 25, wherein the permanent polymer comprises one or more polymers selected from the group consisting of a polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde and a vinyl acetate.

27. The kit of claim 26, wherein the ionomer resin is an ethylene/methacrylic acid.

28. The kit of claim 26, wherein the polyamide is a nylon, wherein the nylon is a nylon 6, a nylon 6,6, a nylon 6,9, a nylon 6,11, a nylon 6,12, a nylon 11 or a nylon 12.

29. The kit of claim 26, wherein the polyvinyl is a PVC/polyacrylic alloy.

30. The kit of claim 26, wherein the fluoropolymer is PTFE, PFA, FEP or ETFE.

31. The kit of claim 25, wherein the polymer sheath comprises one or more polymers selected from the group consisting of a polyurethane, a polystyrene, a polyester, a polyether, a polyethylene, a polybutylene, a polypropylene, a plastisol, a polyacrylic, a polyvinyl, a polyvinylidene, a polysiloxane, a polyisoprene, an epoxy, a polychloroprene, a fluoropolymer, an ionomer resin, a polyamide, a polyimide, a polysulfide, an acetonitrile-butadiene-styrene co-polymer, a styrene-butadiene co-polymer, a styrene-acrylonitrile co-polymer, a styrene-isoprene co-polymer, an ethylene-propylene co-polymer, a plastisol, a phenol-formaldehyde, an urea-formaldehyde, a melamine-formaldehyde, and a vinyl acetate.

32. The kit of claim 25, further comprising one or more tire lubricating agents in a suitable container means, wherein a lubricating agent is selected from the group consisting of a detergent, a soap, an oil, a silicon, a water based jelly, a mineral oil, a graphite and a rust inhibitor.

33. A plastic sheath for covering a lever end of a tire tool, wherein the plastic sheath covering the lever end of the tire tool prevents the marring of a wheel rim when the lever end contacts the wheel rim during a tire mounting or dismounting process.
